(19) United States
(12) Patent Application Publication
(10) Pub. No.: US 2026/0309494 A1
(43) Pub. Date: Oct. 8, 2026

(54) SYSTEMS AND METHODS FOR LOCALIZING AND POSITIONING SOLAR MODULE ARRAYS

(71) Applicant: Planted Solar, Inc., Oakland, CA (US)

(72) Inventors: Ryan Keating, Oakland, CA (US); Nathan Beckett, Oakland, CA (US); Richard Erb, Oakland, CA (US); Rob Stuart, Oakland, CA (US)

(73) Assignee: Planted Solar, Inc., Oakland, CA (US)

(21) Appl. No.: 19/635,290

(22) Filed: Mar. 31, 2026

Related U.S. Application Data
(60) Provisional application No. 63/782,480, filed on Apr. 2, 2025.

(51) Int. Cl. G01C 15/00; G01C 15/06; G01S 17/08; H02S 99/00

(52) U.S. Cl. CPC G01C 15/006; G01C 15/06; G01S 17/08; H02S 99/00

(57) ABSTRACT

The present disclosure describes systems and methods for localizing and positioning one or more sets of 3D data points in the deployment of solar panels. In an aspect, the present disclosure provides a mobile platform comprising a measurement object and a position sensor, and a 3D survey apparatus configured to acquire a first set of 3D data points of the measurement object, wherein the position sensor is configured to acquire a second set of 3D data points at a different location relative to the 3D survey apparatus, and a processor in communication with the 3D survey apparatus and the position sensor, configured to estimate, utilizing an optimization algorithm, a pose of the 3D survey apparatus based at least in part on a difference between the first set of 3D data points and the second set of 3D data points.

### CROSS-REFERENCE TO RELATED APPLICATIONS

This application claims the benefit of U.S. Provisional Application No. 63/782,480 filed 2 Apr. 2025 which is incorporated in its entirety by this reference.

### TECHNICAL FIELD

This invention relates generally to the sustainability field, and more specifically to a new and useful method for localizing and positioning solar module arrays in the sustainability field.

### BACKGROUND

With the recognition of the harmful effects of global warming, the generation of usable power from solar energy is gaining increased acceptance. Large areas of vacant land can offer an attractive location for the deployment of solar panels or solar modules. Deployment of solar panels on such large areas of vacant land can be labor intensive, significantly increasing the cost and timeline of deployment. One such labor intensive activity associated with deployment of solar panels on large areas of vacant land is surveying. Another such labor intensive activity associated with deployment of solar panels on large areas of vacant land is grading and land preparation.

### BRIEF DESCRIPTION OF THE FIGURES

FIG. 1 is a schematic representation of a variant of the method.

FIG. 2 is a schematic representation of a variant of the system.

FIG. 3 is an illustrative example of a variant of the mobile platform pausing at a plurality of stationary dwell locations on a trajectory.

FIG. 4 is a schematic representation of a variant of synchronizing clock measurements.

FIGS. 5A-5C show a example of determining landscape topography for positioning and assembling solar modules.

FIG. 6 shows a digital representation of a design array.

FIG. 7 is an illustrative example of a variant of back-sighting.

FIG. 8 is an illustrative example of a variant of laser tracker local coordinates.

FIG. 9 is an illustrative example of a variant of an alternative to back-sighting.

FIG. 10 is an illustrative example of a variant of an alternative to back-sighting using global coordinates.

FIG. 11 is an illustrative example of a variant of a set of 3D data points.

FIG. 12 is an illustrative example of a variant of optimization of a set of 3D data points.

FIG. 13 is an illustrative example of a variant of clock synchronization of measurements in accordance with some embodiments.

FIG. 14 is an illustrative example of a variant of linear interpolation in measurement synchronization.

FIG. 15 is an illustrative example of a variant of incorrect clock skew.

FIG. 16 is an illustrative example of a variant of a digital representation of the post and solar module assembly.

FIG. 17A shows a digital surface data. FIG. 17B shows a digital representation of the predicted and/or design array components at the terrain.

FIG. 18A is an illustrative example of a variant of a sensor to record array and terrain data during the installation. FIG. 18B is an illustrative example of a variant of an updated digital model with data from the sensor.

FIG. 19A is an illustrative example of a variant of data for the calculation for power produced by the array. FIG. 19B shows a isometric view of a design array exported from the digital representation. FIG. 19C shows a instruction path plan for an installation/construction. FIG. 19D shows a plan view of a design array exported from the digital representation.

FIG. 20 shows an illustrative example of a variant of design information for a solar module array.

FIG. 21 is an illustrative example of a variant of a coordinate system for describing a moving vehicle.

FIG. 22 is an illustrative example of a variant of a GUI for determining a landscape topography for positioning and assembling solar modules.

FIG. 23 is an illustrative example of a variant of a method for autonomously positioning and assembling solar modules.

FIG. 24 shows a overhead view of an autonomous system for positioning and assembling solar modules.

FIG. 25A is an illustrative example of a variant of an arrangement of a row of posts. FIG. 25B is an illustrative example of a variant of an array of posts and solar modules assembled with posts at alternating angles.

FIG. 26A is an illustrative example of a variant assembly of posts and a solar module. FIG. 26B shows another example assembly of posts and a solar module. FIG. 26C shows another example assembly of posts and solar modules.

FIG. 27 is an illustrative example of a variant of main tolerances of concern for a ground mount installation.

FIG. 28Ais an illustrative example of a variant of a side perspective view showing the impact of terrain upon installation. FIG. 28B is an illustrative example of a variant of the ability of a ground mount system, according to some embodiments, to handle relatively high tolerances.

FIGS. 29A-29F, FIGS. 30A-30B, FIGS. 31A-31C, and FIGS. 32A-32B show illustrative examples of variants of vehicles for positioning and assembling solar modules. In some cases, a trailer may comprise a gantry for picking up and/or positioning one or more modules above posts.

FIG. 33 and FIGS. 34A-34C show illustrative examples of perspective views of a machine for installing posts.

FIGS. 35A-35B show examples of a post-module interface with a flexible surface.

FIG. 36A shows a perspective view of an exemplary solar module array, and FIG. 36B shows a plan view of an exemplary solar module array assembly.

### DETAILED DESCRIPTION

The following description of the embodiments of the invention is not intended to limit the invention to these embodiments, but rather to enable any person skilled in the art to make and use this invention.

### 1. Overview

Recognized herein is a need for an improved three-dimensional (3D) surveying method for automated surveying and machine control without or with minimal human intervention while preserving the precision of the measurements.

In an aspect, the present disclosure provides systems and methods for handling and deploying arrays of energy modules. The energy modules may comprise a solar module (or module or solar panel, as used interchangeably) or a plurality of solar modules. The solar modules may comprise a deployable device that is configured to generate energy using one or more resources. In some cases, the one or more resources may comprise solar energy, heat energy, radiation energy, or any other type of energy.

Large areas of vacant land can offer an attractive location for the deployment of solar arrays. Deployment of solar arrays on such large areas of vacant land can be labor intensive, significantly increasing the cost and timeline of deployment. One such labor intensive activity associated with deployment of solar arrays on large areas of vacant land is surveying.

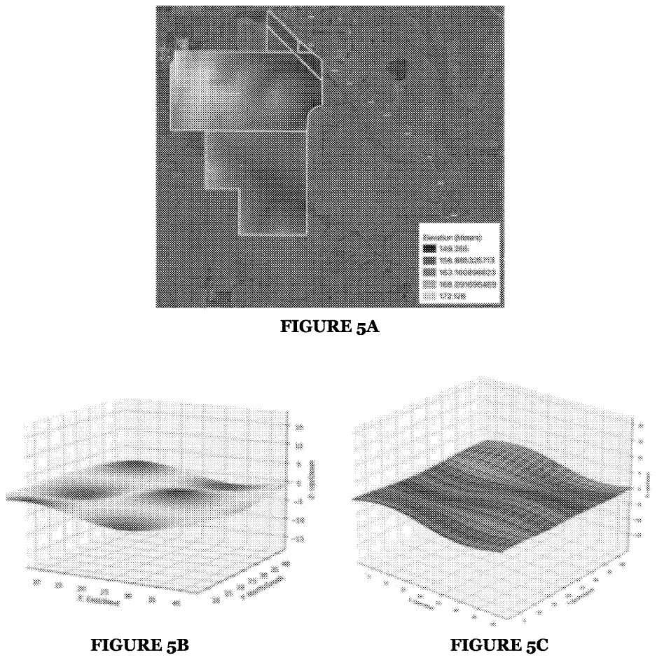

An example of a surveyed area of vacant land for the deployment of solar modules is provided in FIGS. 5A-5C. As can be seen in FIG. 5A, solar arrays may often be deployed on large plots of land in remote areas. Using traditional methods of the art, surveying such a large plot of land would represent a significant cost in time and labor. As can be seen in FIGS. 5B and 5C, these vacant plots of land may often possess topographical features which are important to accurately survey before the deployment of solar arrays.

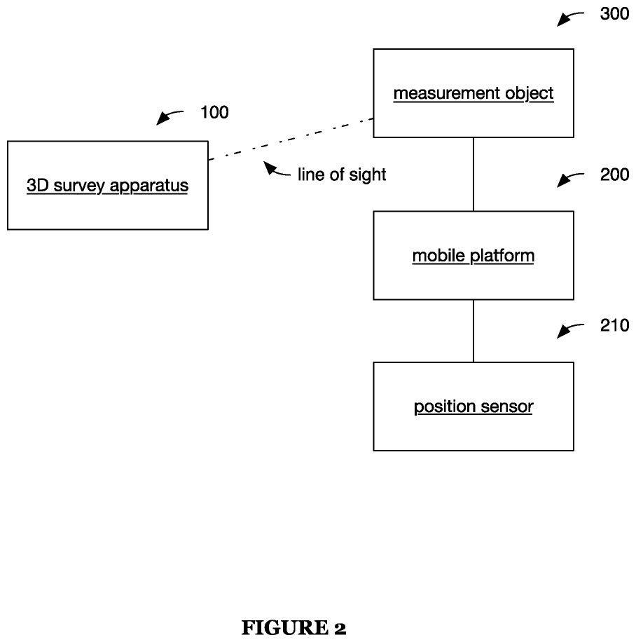

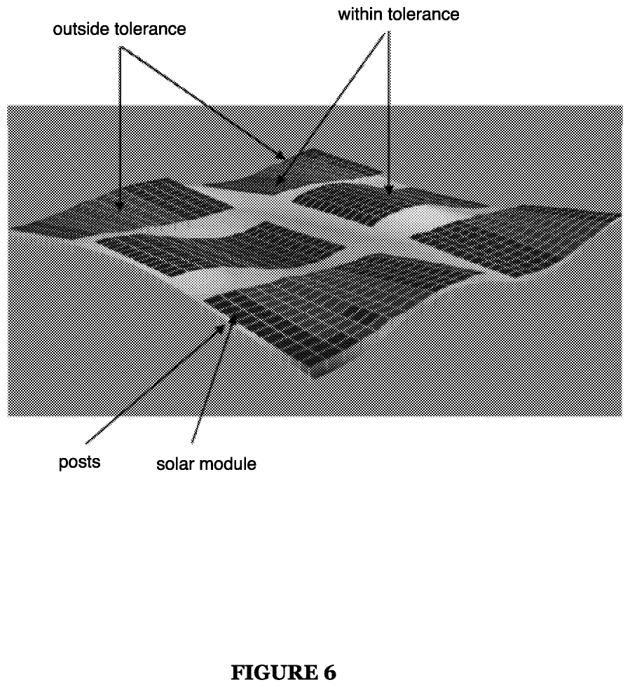

FIG. 6 illustrates the importance of accurately surveyed topographical features in the deployment of solar arrays. Ensuring each deployed solar module within the array is within pre-defined tolerances is imperative for proper functioning and longevity of the array. These tolerances may, for example, be directed to the orientation and angle of the solar module and/or posts that support the solar module, and the proximity to neighboring modules and/or posts in the array. In some cases, the orientation and angle of the solar module and/or post, as well as its proximity to neighboring modules and/or posts in the array may be affected by topographical features. For example, FIG. 2 shows an example of a variant of solar modules in an array which would fall out of the pre-defined tolerances, if deployed. FIG. 2 shows in an example of a variant of solar modules in an array which would remain within the pre-defined tolerances, if deployed.

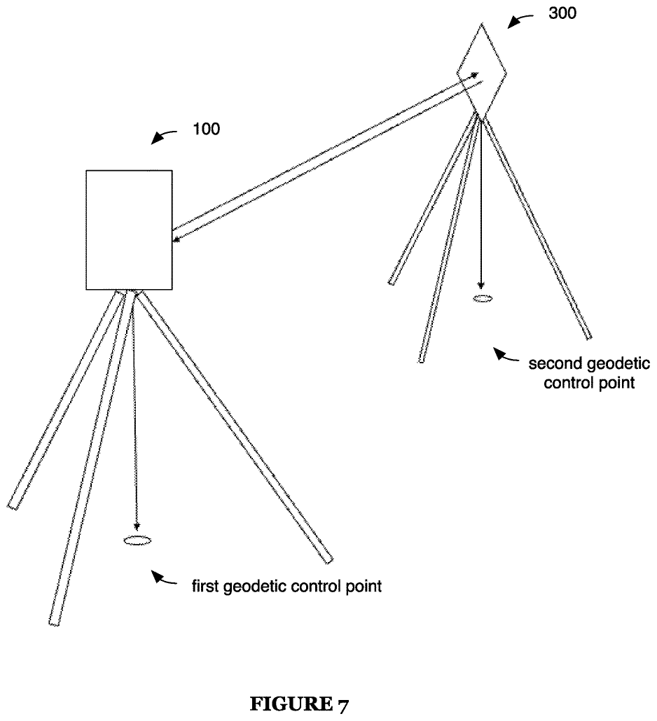

In an aspect, the present disclosure provides a method for three-dimensional (3D) surveying, where the method can operate efficiently without relying upon traditional GCP or backsighting-based techniques (e.g., as shown in FIG. 7).

Embodiments of a method can include acquiring a first set of 3D data points of a measurement object utilizing a 3D survey apparatus, wherein the measurement object is located on a mobile platform; concurrently acquiring a second set of 3D data points utilizing a position sensor located on the mobile platform, where the first set of 3D data points and the second set of 3D data points are acquired in separate coordinate frames; and estimating, utilizing an optimization algorithm, a pose of the 3D survey apparatus based on at least in part a difference between the first set of 3D data points and the second set of 3D data points. The present disclosure provides systems and methods for localizing and positioning one or more sets of 3D data points in the deployment of solar panels and/or various other applications. In particular, methods herein may allow for an automated surveying process without or with minimal human intervention while preserving the precision of measurement. The measurement methods herein can be particularly useful in applications where relative positional and orientational information is critical among objects while the absolute coordinates in a world reference frame is less critical. For instance, in solar panel deployment, the relative positions between solar panels in arrays require high precision while the solar panel arrays may be shifted in the global reference frame with relatively higher tolerance. Optionally, an additional measurement may be employed to further correct the global coordinates if needed.

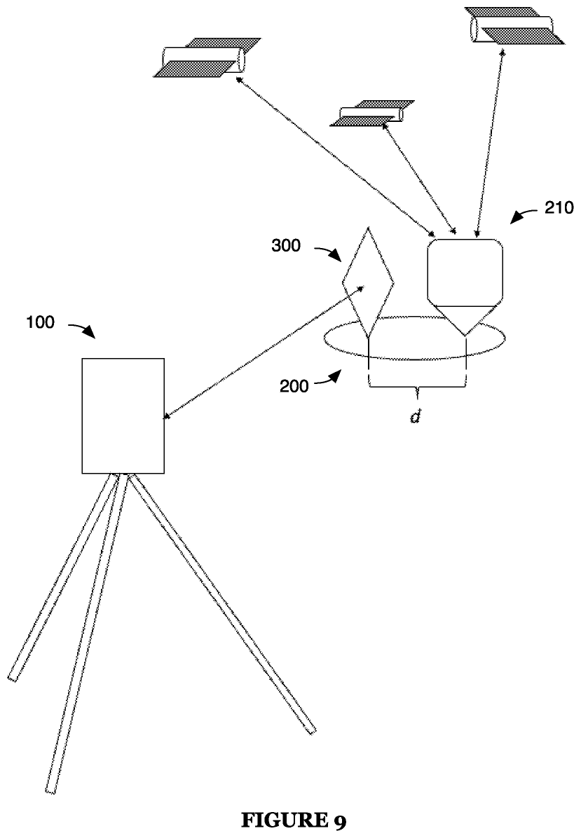

In some embodiments, the measurement object comprises a prism or an optical reflector. In some embodiments, the 3D survey apparatus comprises a laser tracker. In some embodiments, the first set of 3D data points are measurements of a relative location and orientation of the measurement object in an internal coordinate frame of the 3D survey apparatus and the second set of 3D data points are measurements of locations of the measurement in a world coordinate frame. In some embodiments, the position sensor comprises an internal navigation system. In some embodiments, the position sensor and the measurement object have a fixed or known spatial relationship on the mobile platform (e.g., as shown in FIG. 9). In some embodiments, the pose of the 3D survey apparatus is in a world coordinate frame. In some embodiments, the optimization algorithm comprises making an initial guess of estimated pose parameters using a first data point in the second set of 3D data points and optimizing the difference using a non-linear least-square algorithm. In some embodiments, the method further comprises measuring positions of new 3D points based on an estimated pose and measurements acquired using the 3D survey apparatus. In some embodiments, an accuracy of measurements of the positions of the new 3D points is no greater than 1.5 cm or better than an accuracy of the position sensor. In some embodiments, the first set of 3D data points are associated with a first mobile platform comprising a first trajectory and a first set of timestamps generated using a first clock and the second set of 3D data points are associated with a second mobile platform comprising a second trajectory and a second set of timestamps generated using a second clock that is not synchronized with the first clock. In some embodiments, the first set of 3D data points and the second set of 3D data points are acquired at different frequencies. In some embodiments, the method further comprises synchronizing the first set of 3D data points and the second set of 3D data points based on a relationship between clock parameters of the first clock and the second clock. In some embodiments, the relationship between clock parameters is obtained by interpolating a timestamp between two timestamps from the second set of timestamps based at least in part on the difference between one point in the first trajectory and two points in the second trajectory. In some embodiments, an initial estimate of the relationship between clock parameters is obtained by using a linear least-square regression on the first set of timestamps and at least the interpolated timestamp. In some embodiments, the initial estimate of the relationship between clock parameters is further refined jointly with the pose of the 3D survey apparatus.

In another aspect, the present disclosure provides a system for three-dimensional (3D) surveying, the system comprising a mobile platform comprising a measurement object and a position sensor, and a 3D survey apparatus configured to acquire a first set of 3D data points of the measurement object, wherein the position sensor is configured to acquire a second set of 3D data points at a different location relative to the 3D survey apparatus, and a processor in communication with the 3D survey apparatus and the position sensor, configured to estimate, utilizing an optimization algorithm, a pose of the 3D survey apparatus based at least in part on a difference between the first set of 3D data points and the second set of 3D data points.

In some embodiments, the measurement object comprises a prism or an optical reflector. In some embodiments, the 3D survey apparatus comprises a laser tracker. In some embodiments, the first set of 3D data points are measurements of a relative location and orientation of the measurement object in an internal coordinate frame of the 3D survey apparatus and the second set of 3D data points are measurements of locations of the measurement in a world coordinate frame. In some embodiments, the position sensor comprises an internal navigation system. In some embodiments, the position sensor and the measurement object have a fixed or known spatial relationship on the mobile platform. An example is shown in FIG. 9. In some embodiments, the pose of the 3D survey apparatus is in a world coordinate frame. In some embodiments, the optimization algorithm comprises making an initial guess of estimated pose parameters using a first data point in the second set of 3D data points and optimizing the difference using non-linear least-square algorithm. In some embodiments, the survey apparatus is further configured to measure positions of new 3D points based on the estimated pose and measurements acquired using the 3D survey apparatus. In some embodiments, an accuracy of measurements of the positions of the new 3D points is no greater than 6 cm vertically and 3 cm laterally or better than an accuracy of the position sensor. In some embodiments, the first set of 3D data points are associated with a first set of timestamps generated using a first clock and the second set of 3D data points are associated with a second set of timestamps generated using a second clock that is not synchronized with the first clock. In some embodiments, the survey apparatus and position sensor are configured to acquire the first set of 3D data points and the second set of 3D data points at different frequencies. In some embodiments, the processor is configured to synchronize the first set of 3D data points and the second set of 3D data points based on a relationship between clock parameters of the first clock and the second clock. In some embodiments, the processor is configured to obtain the relationship between the first clock and the second clock by interpolating a timestamp between two timestamps from the second set of timestamps based at least in part on a moving speed or velocity of the mobile platform. In some embodiments, the processor is configured to obtain an initial estimate of the relationship between the first clock and the second clock by using a liner least-square regression on the first set of timestamps and at least the interpolated time stamp. In some embodiments, the processor is configured to further refine the initial estimate of the relationship between clock parameters using a non-linear least-square regression.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### 2. Technical Benefits

Variants of the technology can confer one or more advantages over conventional technologies.

First, variants of the technology can eliminate the need for requiring reliance upon existing geodetic control points (GCPs) or expert placement (e.g., in relation to traditional backsighting techniques), and can operate without surveying infrastructure on raw land. Unlike conventional optical surveying methods that require pre-existing GCPs or manual placement by licensed surveyors, the technology can autonomously establish positioning references through mathematical estimation of the three dimensional (3D) survey apparatus world-frame pose from trajectory data. This can significantly reduce project setup time and costs, particularly for solar installations on undeveloped terrain where establishing survey infrastructure would otherwise be required.

Second, variants of the technology can operate without skilled operator input to level instruments, as the robotic platform can drive around autonomously. Traditional surveying methods require trained personnel to manually level and orient total stations, a process that can be time-consuming and subject to human error. By automating the positioning and operation of survey equipment, the technology can reduce labor costs and eliminate the need for specialized surveying expertise on-site.

Third, variants of the technology can overcome limitations of traditional optical surveying that requires an operator and the need to move a second total station for back-sighting procedures. Conventional methods require manual setup, physical leveling over control points, and orientation toward secondary reference points using known distances for calibration. The technology can eliminate these manual procedures by mathematically determining the survey apparatus pose through trajectory optimization, enabling continuous operation without repositioning requirements.

Fourth, variants of the technology can provide continuous background monitoring of residuals through real-time optimization algorithms. The nonlinear least-squares optimization process can continuously assess measurement quality by monitoring the aggregate difference between total station-measured positions and corresponding GPS-measured positions. This can enable immediate detection of measurement anomalies and provide ongoing quality assurance throughout the surveying process.

Fifth, variants of the technology can achieve high accuracy comparable to or higher than conventional position sensors, with surveying accuracy of less than about 50 millimeters (mm), less than about 20 mm, less than about 10 mm, less than about 5 mm, or less than about 1 mm. The technology can provide accurate topological data of terrain that enables precise array design including density of solar modules, density of posts, post locations, distances between posts, post heights, solar module orientations, and distances between solar modules. This precision can guide accurate installation of posts and solar modules that conforms to the array design requirements.

Sixth, variants of the technology can address the precision requirements for solar module array deployment, which requires three-dimensional positioning of posts, brackets, and modules to within approximately 20 millimeters across terrain spanning hundreds of meters. Standard GPS can achieve only ±5 meters accuracy, and even INS-aided GPS with RTK corrections can achieve only ±1.5 centimeters per point, with compounding errors that accumulate beyond installation tolerances. The technology can provide positioning accuracy of approximately ±9-15 mm without error compounding, making it suitable for high-precision array deployment requirements.

Seventh, variants of the technology can overcome operational burdens associated with conventional total station surveying while maintaining precision. Traditional total station methods can achieve ±1 mm precision but require back-sighting procedures involving licensed surveyors, pre-existing geodetic control points, manual setup processes, and repeated calibration when relocating equipment. The technology can maintain comparable precision while eliminating these requirements through autonomous operation and mathematical pose estimation.

Eighth, variants of the technology can improve efficiency of the surveying process by eliminating geodetic control points and manual back-sighting procedures. The technology can estimate 3D survey apparatus world-frame pose mathematically from trajectory data collected by a mobile platform carrying co-mounted sensors with fixed spatial offset. A nonlinear least-squares optimization algorithm can minimize aggregate differences between total station-measured positions transformed into world coordinates and corresponding GPS-measured positions, achieving autonomous pose estimation accurate to approximately ±9-15 mm without pre-placed survey infrastructure.

Ninth, variants of the technology can provide non-compounding positional error characteristics that manifest as small, approximately constant offsets applied uniformly to entire point clouds. This error behavior can leave relative precision between points within clusters unaffected, which can be well-matched to solar array installation requirements where adjacent posts and modules must be positioned relative to one another within tight tolerances while absolute global registration carries higher tolerance. The surveyed point cloud can be produced directly in world coordinates and can feed into computer program products that generate post locations, driving depths, tilt angles, module orientations, and robotic traversal paths, enabling end-to-end autonomous deployment workflows with minimal human involvement.

However, further advantages can be provided by the system and method disclosed herein.

### 3. System

As shown in FIG. 2 and FIG. 9, embodiments of a system can include a 3D survey apparatus 100 (e.g., a total station); a mobile platform 200 (e.g., a robot); and a measurement object 300. The system functions to localize a mobile platform in space and/or to facilitate precise and accurate installation of components of a solar array, in relation to surveying and usage of land to support deployment of solar arrays. Surveying and deployment of solar arrays on large areas of vacant land can be labor intensive, significantly increasing the cost and timeline of deployment. Surveying can include gathering, positioning, and/or locating two-dimensional (2D) or three-dimensional (3D) positions of points or objects, and/or the distances and angles between them. In some embodiments, surveying may comprise gathering, positioning, and/or locating one or more sets of 3D data points at least in part by determining the spatial relationship between different data points of the one or more sets of 3D data points. The gathering, positioning, and locating of one or more sets of 3D data points may be performed in real time. The gathering, positioning, and locating of one or more sets of 3D data points may be performed simultaneously. The gathering, positioning, and locating of one or more sets of 3D data points may be done asynchronously. Embodiments, variations, and examples of the system described herein can perform one or more aspects of method described.

### 3.1 System—3D Survey Apparatus (Total Station)

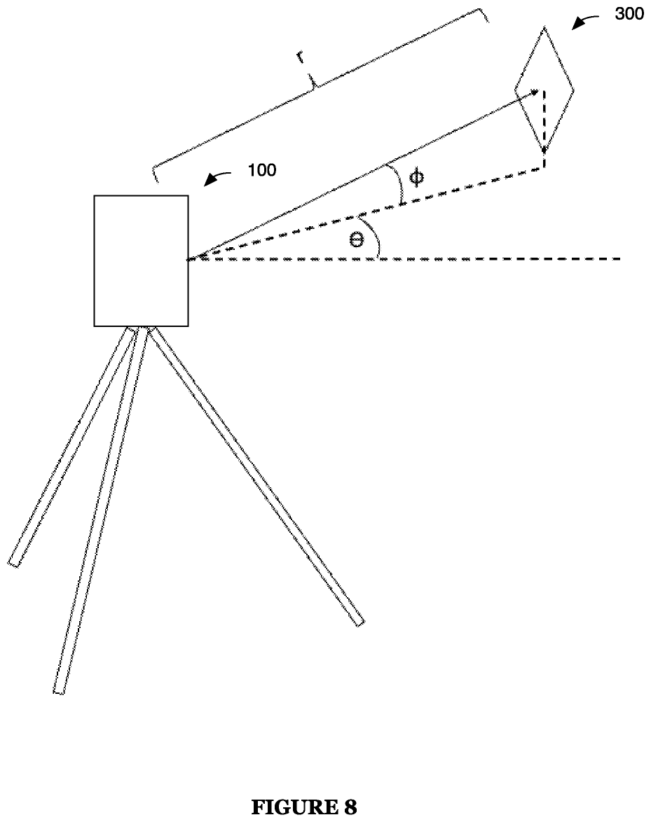

The 3D survey apparatus 100 (e.g., a total station) of the system functions to localize the mobile platform 200 in the world coordinate frame. The laser tracker functions to measure the measurement object 300 (e.g., object with a reflector) using a laser beam (e.g., as shown in FIG. 9). The laser tracker can shine a laser beam at the measurement object and, by way of the reflection of the laser beam, measure the radial distance from the time-of-flight of the laser, the horizontal azimuthal angle, and the vertical polar angle of reflected light signals (e.g., as shown in FIG. 8).

The laser beam measurement can have a precision of 1 mm, 0.1-1 mm, 0.1-10 mm, 9-15 mm, 1-20 mm, 10-50 mm, and/or any value therebetween, thereby providing high-performance accuracy and precision of surveying and/or solar panel placement operations.

The laser tracker preferably has an optical line of sight to the measurement object during operation, but can alternatively be otherwise configured.

The 3D survey apparatus 100 (e.g., a total station) can be arranged on a mobile platform 200, but can alternatively be stationary. The 3D survey apparatus (e.g., a total station) can be arranged at a jobsite by an operator, autonomously positioned or deployed (e.g., in variations in which components of the 3D survey apparatus are robotic), semi-autonomously positioned (e.g., autonomously deployed, with fine positioning and/or repositioning performed manually), and/or otherwise arranged. The mobile platform preferably does not require certification to set up, but can additionally and/or alternatively require certification to set up.

The 3D survey apparatus 100 can include a ground contact system having one or more legs, stakes (e.g., to be driven into the ground), wheels, and/or any other ground contact system. In variants, the ground contact system can include one or more legs, stakes (e.g., to be driven into the ground), wheels, or other elements. The ground contact system can extend and/or retract the elements (e.g., after deployment of the 3D survey apparatus to a position for measurement). The ground contact system can function to stabilize the 3D survey apparatus (e.g., a total station) in a stationary pose and/or between instances of moving the 3D survey apparatus.

### 3.2 System—Mobile Platform (Robot)

The mobile platform 200 (e.g., a robot) functions to acquire a set of 3D data points in global coordinates and/or to facilitate acquisition of measurements for installation of components of a solar array.

The mobile platform 200 (e.g., a robot) can be a self-propelled ground robot (e.g., wheeled, tracked, legged, etc.), an autonomous vehicle, a semi-autonomous vehicle, a remotely-operated platform, an aerial platform, and/or any other mobile platform.

The mobile platform 200 can include a set of sensors, a processing system, a chassis, a propulsion system, energy storage (e.g., a battery), and/or any other components. The set of sensors can include positional sensors 210, vision sensors, ultrasonic sensors, audio sensors (e.g., microphones), motion sensors, proximity sensors, temperature sensors, chemical sensors, biological sensors, odometers (e.g., wheel odometers), and/or any other sensors. The positional sensors can include GPS, INS, and/or any other positional sensors. The vision sensors can include light detection and ranging (LIDAR) sensors, a camera, a thermal camera, an infrared sensor, an ultraviolet sensor, and/or any other vision sensors. The motion sensors can include an inertial measurement unit (IMU), an accelerometer, a gyroscope, and/or any other motion sensors.

The mobile platform 200 can include or communicate with a processing system structured to process data from the set of sensors, can receive, store, and/or process sets of 3D data points, can control movement of the mobile platform, and/or can otherwise function. The processing system can receive, store, and/or process sets of 3D data points, where the processing system can localize and position solar module arrays as described in the method. In an example, the mobile platform (e.g., a robot) can receive sets of 3D data points from a total station and a position sensor.

The mobile platform 200 can include a chassis that provides a foundational, load-bearing framework for the mobile platform, where the chassis supports aspects of the mobile platform described.

The mobile platform 200 can include a suitable propulsion system having any suitable combination of components, such as wheels, rollers, treads, axles, propellers, engines, motors, and the like. For example, a ground-based propulsion system can enable the mobile platform to travel over various types of terrain, including paved surfaces (e.g. roads, sidewalks), unpaved surfaces (e.g. grass, dirt, gravel), flat surfaces, inclined or uneven surfaces (e.g. hills, lopes, speed bumps), and so on. The propulsion system of the mobile platform can enable it to move within the environment with up to six degrees of freedom of motion (e.g. up to three degrees of freedom in translation, up to three degrees of freedom in rotation). In some instances, the movement of the mobile platform can be constrained with respect to one or more degrees of freedom. For example, the mobile platform can be limited to movements on the ground.

The mobile platform 200 can include energy storage components (e.g., a battery), which can be chargeable from a renewable energy system (e.g., solar), but can alternatively not be chargeable. In a variant, the mobile platform (e.g., a robot) can be charged at mobile or stationary charging stations at a jobsite.

In relation to mobility, the mobile platform 200 (e.g., a robot) is preferably self-propelled, but can alternatively be propelled by another component.

The mobile platform 200 can navigate using sensors (e.g., positional sensors, vision sensors, motion sensors, etc.), odometry, pre-loaded maps and/or waypoints, environmental landmarks, and/or any other navigation methods. The environmental landmarks can include paint, waypoint markers, previously placed modules or markers, illuminated objects, reflective objects, other objects, and/or any other environmental landmarks. The mobile platform (e.g., a robot) can navigate through or across ground, water, and/or aerial environments.

The mobile platform 200 (e.g., a robot) can preferably navigate terrain such as paved and unpaved surfaces, flat and inclined/uneven surfaces (e.g., hills, slopes, speed bumps, etc.), slopes up to 30 degrees, up to 50 degrees, 30-50 degrees, or more than 50 degrees, and/or any other terrain, but can additionally and/or alternatively navigate otherwise.

The mobile platform 200 (e.g., a robot) can operate within sparse environments (e.g., open land) and/or populated environments such as urban, suburban, or active jobsite environments. In variants, the mobile platform can be specifically adapted to detect and/or interact with humans, animals, plants, vehicles, other mobile platforms, manmade structures (e.g., buildings, roads, traffic signals, solar modules in an array), and/or any other entities commonly found within a populated or active job site setting. For example, a mobile platform (e.g., a robot) can be capable of avoiding collisions with objects, humans, animals, vehicles, avoiding drop-offs and steep terrain, and/or any other hazards. As another example, the mobile platform (e.g., a robot) operating within a jobsite can be capable of identifying and obeying jobsite signals and avoiding jobsite traffic. As another example, a fleet of mobile platforms (e.g., a robot) deployed on a jobsite can be capable of operating autonomously or semi-autonomously while avoiding collisions with each other.

As such, in variants, the mobile platform 200 (e.g., a robot) can preferably detect and/or interact with humans, animals, plants, vehicles, other mobile platforms, manmade structures, and/or solar modules in array, but can additionally and/or alternatively detect and/or interact with other objects or entities (or to modify movement in relation to detected objects while performing tasks). As such, the mobile platform can preferably avoid collisions, avoid drop-offs and steep terrain, identify and respond to jobsite signals, and/or otherwise perform any other functions.

The autonomous navigation capabilities of the mobile platform 200 (e.g., a robot) provided herein can utilize various parameters, such as data received from vehicle sensors described herein, supporting vehicles received from various sources (e.g., GPS beacons, color patterns, RFID), autonomous vehicle algorithms (e.g., implemented by a suitable onboard processor and/or controller) and information regarding the environment (e.g. maps, waypoints, and/or any other information stored in an onboard memory or transmitted to the mobile platform from a remote source).

In some embodiments, the mobile platform 200 navigation can utilize information (e.g., previously provided information) of landmarks within the environment, which can be manmade or natural structures such as paint on the ground surface, waypoint markers, previously placed solar modules in an array, and/or any other structures.

The mobile platform 200 (e.g., a robot) can perform one or more tasks in the deployment of a solar module in an array, described herein, where the tasks can be performed in parallel, in sequence, or suitable combinations thereof.

The mobile platform 200 (e.g., a robot) can operate as an individual robot, or as part of a fleet of multiple mobile units. For example, a plurality of mobile units can be deployed each to perform one or more tasks in the deployment of a solar module in an array, described herein. Relatedly, the mobile platform (e.g., a robot) can optionally be configured to perform one or more of the same tasks as another mobile unit in the fleet. Relatedly, each mobile platform (e.g., a robot) can be configured to perform one or more different tasks as another mobile platform in the fleet.

The mobile platform 200 (e.g., a robot) can be configured to manipulate solar array components (e.g., posts, brackets, solar modules), but can alternatively manipulate other components. In a first variant, the mobile platform (e.g., a robot) can install posts (e.g., drive or pound posts into the ground). In a second variant, the mobile platform (e.g., a robot) can install brackets (e.g., couple a bracket to a post on axis with the post). In an example of the second variant, the mobile platform can include pushing a bracket down over the top of a post until it stops (e.g., from a backstop).

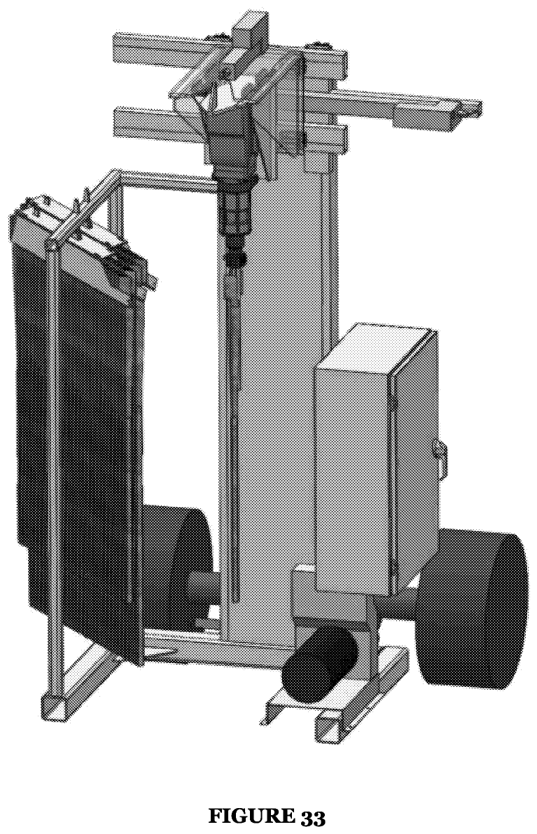

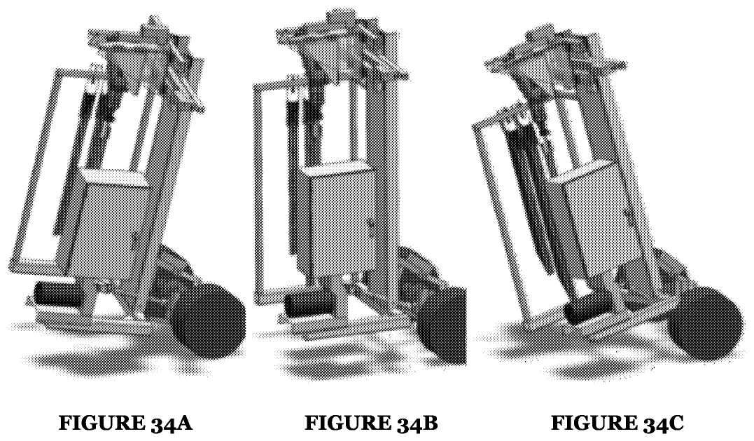

The mobile platform 200 (e.g., a robot) can include installation machineries including a post singulator, which functions to singulate a post from a plurality of posts (e.g., bulk posts); a post installer, which functions to drive a post into the terrain; and/or a solar module installer. The post installer (e.g., an example is shown in FIG. 33 and FIGS. 34A-C) can include 3, 4, 5, or 6 degrees of freedom or more. In some cases, the post installer can autonomously position a post, install the post in the ground, and/or force-test the post by pulling on it laterally, vertically, or any other direction and record the force-test data. In some cases, the post installer can be configured to carry one or more bundles of posts on a rack. In some cases, the post installer can be configured to locate one or more posts in a bundle of posts and collect a new post on a driving bit.

The solar module installer can include a clinch tool. The clinch tool functions to form a connection between the modules and the one or more posts, as described in greater detail below. In some cases, the clinch tool can fit between ears of a post and a clip. In some cases, the clinch tool can close to form a joint. In some cases, the module installer can release the clinch tool. In some cases, an end effector can be used to handle the tool and/or install the module. In some cases, a module installer can drive to another set (or next set) of one or more posts to install another module (or a next module).

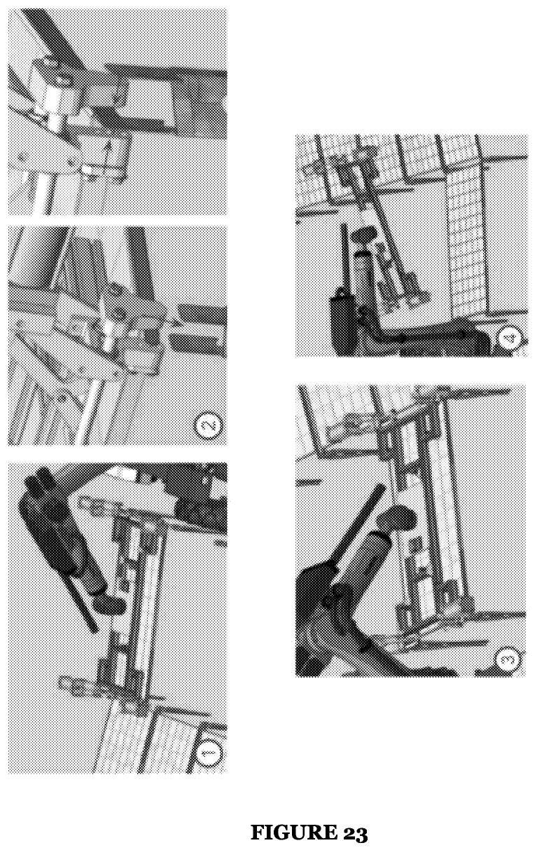

FIG. 23 shows an example of autonomously positioning and assembling solar modules, in accordance with some embodiments. In some cases, a module installer (e.g., a robot) may drive to a location. The location may be determined by a user or an operator of the robot, or based on sensor data. In some cases, a module installer can pick up an energy module (e.g., a solar module). In some cases, a module installer can position the module over 1, 2, 3, 4, or more posts. The posts may be installed autonomously by another robot.

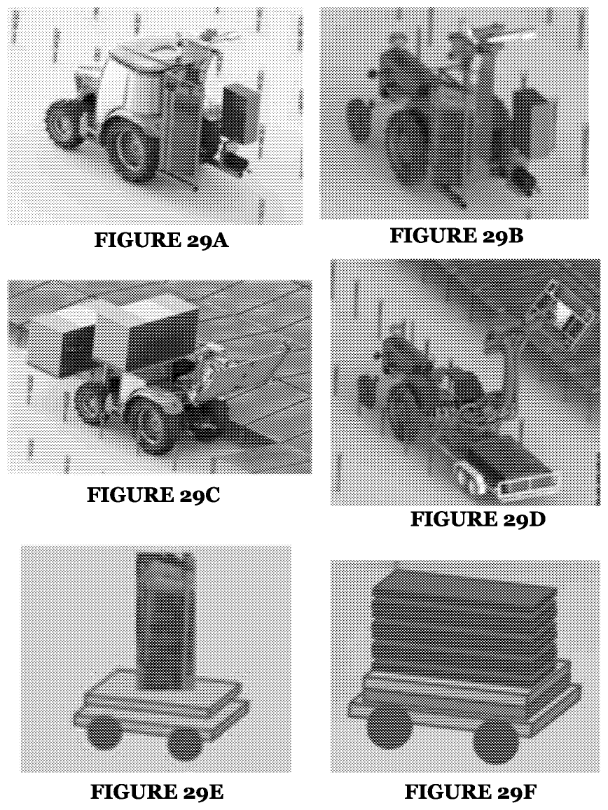

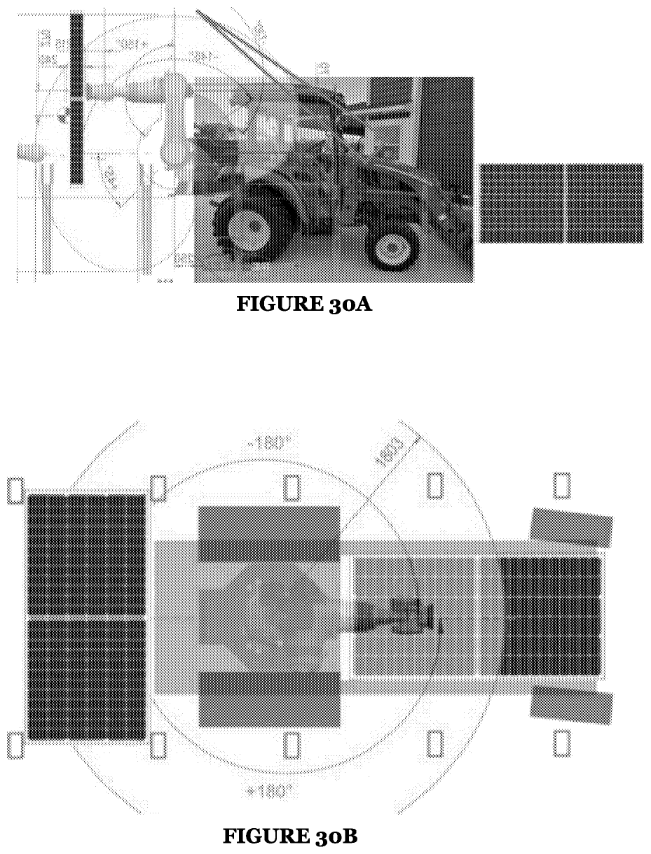

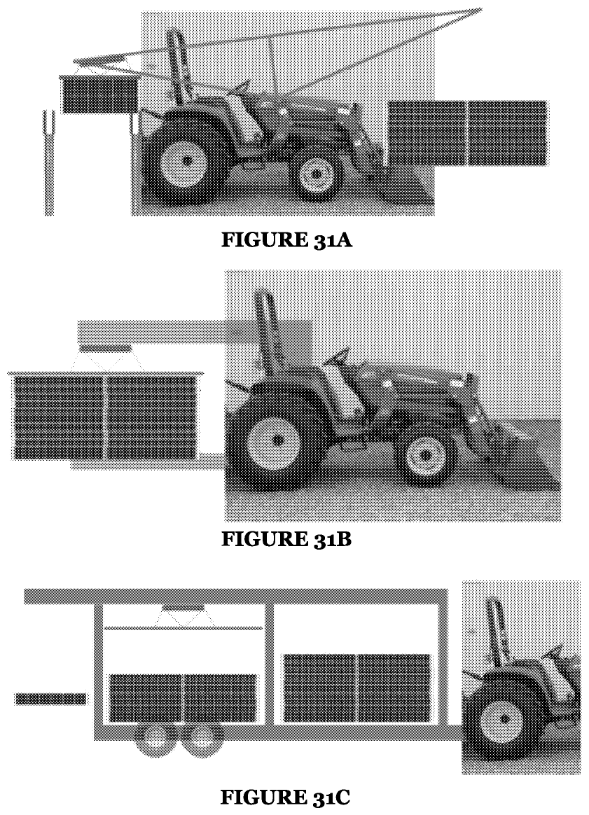

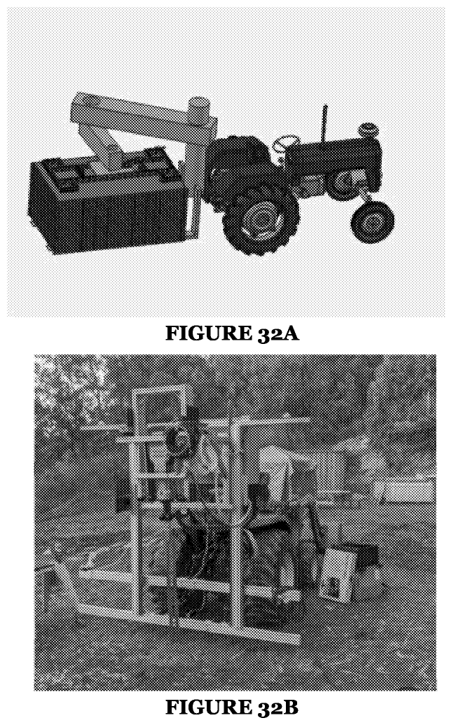

FIGS. 29A-F, FIGS. 30A-B, FIGS. 31A-C, and FIGS. 32A-B show vehicles for positioning and assembling solar modules, in accordance with some embodiments. In some cases, a module installer can be a custom machine built on a vehicle. In some cases, a module installer can take in a stack of solar modules. In some cases, the stack of solar modules can be placed on the module installer. In some cases, the stack of solar modules can be picked up by the module installer. In some cases, the module installer can carry the stack of modules. In some case, the module installer can separate one module from the stack of modules. In some cases, the module installer can position the one module over a plurality of installed posts, for example, two, three, four, or more installed posts. In some cases, the module installer can lower the module into a predetermined position over the plurality of installed posts.

In some cases, the module installer can couple, install, or connect the module to the plurality of post. In some cases, the module installer can deform a metallic portion of a module to create a rigid connection between the module and the post. In some cases, the module installer can release the module. In some cases, the module installer can test a strength of connections formed between the module and the plurality of posts by lifting, pushing, twisting, or any sufficient force.

In some cases, the module installer can drive to a next location to place a module. In some cases, a module installer can include 3, 4, 5, or 6 degrees of motion or more. In some cases, a module installer can include a robot arm that is configured to receive a module from a flipping machine. In some cases, a robot arm can be used to reach for and pick up a module from a stack. In some cases, a gantry can be used to tilt back and forth to pick up a module and position the module behind. In some cases, a double rotary motion manipulator comprising one or more rotating joints can be used to position a module above one or more posts. In some cases, a gantry can be used to pick up and position one or more modules onto one or more installed posts. In some cases, a trailer can include a gantry for picking up and/or positioning one or more modules above posts.

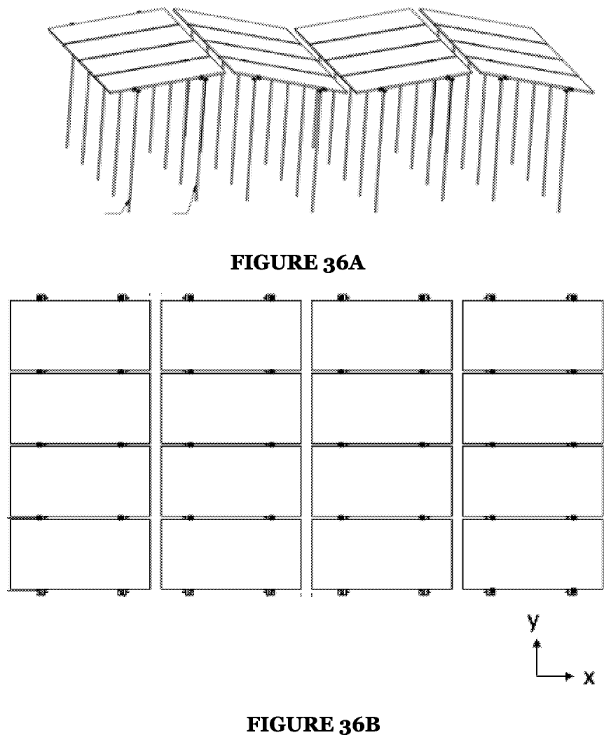

The mobile platform 200 (e.g., a robot) can be used to position and deploy supporting structures (e.g., a plurality of posts configured to support the plurality of solar modules) for a solar array. The solar array can include one or more solar modules, wherein a solar module can be mounted to one or more posts. In an example, at least one solar module of the plurality of solar modules can be supported by two or more posts at a plurality of non-corner positions along a first longitudinal side of the at least one solar module (e.g., as shown in FIG. 36B).

In some cases, the first longitudinal side of the at least one solar module can include a first end and a second end. In some cases, the two or more posts can be located away from the first end and the second end. In some cases, the two or more posts can be located other than at the first end and/or the second end. In some cases, the two or more posts can be located at least about 0.5 inch (in) away from the first end and the second end. In some cases, the two or more posts can be located at least about 1 inch (in) away from the first end and the second end. In some cases, the two or more posts can be located at least about 2 in, at least about 3 in, at least about 4 in, at least about 5 in, at least about 6 in, at least about 7 in, at least about 8 in, at least about 9 in, at least about 10 in, at least about 11 in, at least about 12 in, or more, away from the first end and the second end.

The mobile platform 200 (e.g., a robot) can install a first post at a first location and a second post at a second location. The first location and the second location can be sufficiently close such that an energy module can be installed to be supported by both the first post and the second post. Two separate energy modules can be installed to be supported by each of the first post and the second post, respectively. The first post can be installed first, and the second post can be installed second. The first post and the second post can be installed substantially at about the same time. A first mobile platform can install a first post at a first location and a second mobile platform can install a second post at a second location. Various number of posts can be installed by a given mobile platform. One or more posts can be installed at various locations by a given mobile platform.

In variations, the plurality of mobile platforms (e.g., robots) can be configured to operate as a fleet or a swarm. The plurality of mobile platforms (e.g., robots) can communicate with one or more servers configured to control an operation or a movement of the plurality of mobile platforms (e.g., robots) within an area or location comprising the sensed geolocation. The server can provide different commands to different mobile platforms (e.g., robots), or command different mobile platforms (e.g., robots) to collaboratively perform one or more tasks. It shall be understood that the coordination of one or more mobile platforms (e.g., robots) can be implemented in various configurations to achieve a similar effect, for example, by using various number of mobile platforms (e.g., robots), various types of mobile platforms (e.g., robots), various number of posts, and various rulesets or algorithms for coordinating the mobile platforms (e.g., robots).

In variations, the plurality of mobile platforms (e.g., robots) can be configured to operate in a coordinated manner such that a time taken to perform the one or more tasks is optimized. For instance, a first set of mobile platform(s) (e.g., robot(s)) can coordinate to install one or more posts at a first location and then immediately at a second location. A second set of mobile platform(s) (e.g., robot(s)) can coordinate with the first set of mobile platform(s) (e.g., robot(s)) to install a solar module at the first location immediately as the one or more posts are installed at the first location. In some cases, the first location can be a region near the mobile platform (e.g., a robot). In some cases, the first location can be a region near where the solar module is stored. In some cases, the second location can be near the first location. In some cases, the second location can be a geo-sensed location (e.g., a location that is determined or identified using one or more positions sensors and/or geographical or topological data). In some cases, the second location can be an approximate location, and the approximate location can be adjusted in real-time to be a more precise location.

In variations, the mobile platform 200 (e.g., a robot) can be used to fully autonomously position and assemble the at least one solar module and its supporting structure in two or more different directions. The two or more different directions can include a first direction and a second direction. The first direction and the second direction can be parallel to each other. Alternatively, the first direction and the second direction can be disposed at an angle relative to each other. The angle can be between 0 -180 degrees or any range or value therebetween. The angle can alternatively be less than 0 degrees or greater than 180 degrees.

In variations, the at least one robot can use a movable member to handle the solar module or any components or supporting structures thereof. In some cases, the at least one robot can move the solar module or any components or supporting structures thereof by translating along one, two, or three Euclidean dimensions. In some cases, the at least one robot can move the solar module or any components or supporting structures thereof by rotating the solar module around one, two, or three axes of the solar module. In some cases, the at least one robot can translate and rotate the solar module simultaneously. In some cases, the at least one robot can translate the solar module and then rotate the solar module subsequently, or vice versa. In some cases, for a solar module that is substantially rectangular in shape, an axis of a solar module can be defined as the normal direction from the plane of the solar module having the largest area, the plane of the solar module having the second largest area, or the plane of the solar module having the third largest plane. The at least one robot can move the solar module in various ways, including changing a position and/or an orientation of the solar module or the components of the solar module.

In variations, the mobile platform 200 (e.g., a robot) can reposition and/or re-orient the solar module, supporting structures, and/or any components thereof to be more precise and/or ensure proper installation during deployment. In some cases, the mobile platform (e.g., a robot) can reposition and/or re-orient a given post to ensure a successful insertion of the post into the ground.

The mobile platform 200 (e.g., a robot) can be configured as shown in FIG. 23, which illustrates an exemplary method for autonomously positioning and assembling solar modules, in accordance with some embodiments. In some cases, the mobile platform (e.g., a robot) can drive to a location. The location can be determined by a user or an operator of the robot, or based on sensor data. In some cases, the mobile platform (e.g., a robot) can pick up an energy module (e.g., a solar module). In some cases, the mobile platform (e.g., a robot) can position the module over 1, 2, 3, 4, or more posts. The posts can be installed autonomously by another robot.

In some embodiments, the method can include using the mobile platform (e.g., a robot) to fully autonomously position and assemble a plurality of solar modules and associated supporting structures to construct a solar module array. In some cases, the plurality of solar modules and the associated supporting structures can include at least one solar module and a supporting structure for the at least one solar module.

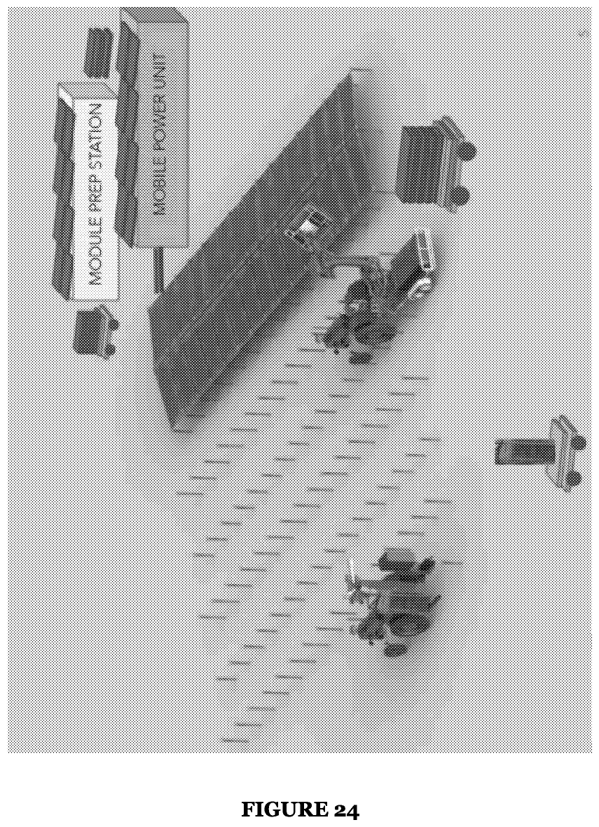

FIG. 24 shows an overhead view of an autonomous system for positioning and assembling solar modules, in accordance with some embodiments. In some cases, the vehicles (e.g., tractors) for deploying posts or solar modules can be fully electric. In some cases, a mobile power unit can be disposed at or near a site wherein the vehicles can charge. In some cases, the mobile power unit can include one or more solar panels and/or batteries. In some cases, a reloading unit can travel between stations. In some cases, a reloading unit can carry posts, solar modules, or any combination thereof. In some cases, a reloading unit can travel between a preparation station or prep station and active installer units (e.g., the autonomous vehicles or robots described elsewhere herein).

The mobile platform 200 (e.g., a robot) can preferably detect when a quantity of solar array components drops below a threshold, but can additionally and/or alternatively be otherwise configured. In a variant, the mobile platform (e.g., a robot) can return to a restocking station (e.g., a central facility, a dedicated restocking vehicle) to replenish components. In a specific example of the variant, the mobile platform can summon a dedicated restocking vehicle to travel to the mobile platform.

However, the mobile platform 200 (e.g., a robot) may be otherwise configured.

### 3.3 System—Measurement Object with Optical and/or Reflector Elements

The measurement object 300 functions to be measured by the 3D survey apparatus. The measurement object can include a prism, an optical reflector (e.g., full-size, mini, 360 degree, etc.), an active target, and/or any other target.

Features (e.g., pose aspects, location aspects, orientation aspects, position aspects, etc.) of the measurement object is preferably measured by the total station (e.g., using a laser tracker), but can alternatively be measured by any other suitable measurement device.

The measurement object 300 can be arranged on the mobile platform (e.g., a robot, a vehicle, etc.), deployed at a fixed location, deployed by an operator, mounted on a structure, and/or otherwise deployed.

The measurement object 300 can be coupled to an end effector of a mobile platform, to a stationary component of the mobile platform relative to the chassis of the mobile platform, to a position sensor of the mobile platform, and/or any other coupling location.

The measurement object 300 preferably has a fixed spatial relationship relative to an element of the mobile platform (e.g., an end effector of the mobile platform, a position sensor, a chassis of the mobile platform, etc.), but can alternatively have any other spatial relationship.

The measurement object 300 can preferably have a known spatial relationship to an element of the mobile platform (e.g., an end effector of the mobile platform, a position sensor, a chassis of the mobile platform, etc.), but can alternatively have any other spatial relationship.

However, the measurement object 300 may be otherwise configured.

Embodiments, variations, and examples of system components can include aspects described in one or more of: U.S. application Ser. No. 17/821,087 filed on 19 Aug. 2022; U.S. application Ser. No. 17/187,126 filed on 26 Feb. 2021; U.S. application Ser. No. 19/061,792 filed on 24 Feb. 2025; U.S. application Ser. No. 19/388,706 filed on 13 Nov. 2025, each of which is incorporated herein in its entirety by this reference.

### 4. Method

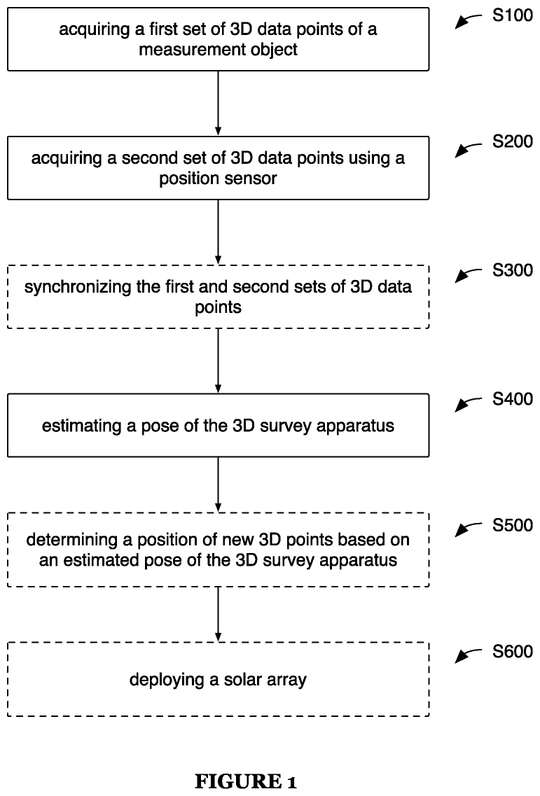

As shown in FIG. 1, an embodiment of a method can include acquiring a first set of 3D data points of a measurement object S100; acquiring a second set of 3D data points using a position sensor S200; optionally, synchronizing the first and second sets of 3D data points S300; estimating a pose of the 3D survey apparatus S400; optionally, determining a position of the mobile platform based on an estimated pose of the 3D survey apparatus S500; and optionally, deploying a solar array S600. The method functions to localize a 3D survey apparatus in a global coordinate frame without reliance upon positioning/repositioning of a surveying apparatus relative to GCP and/or reliance upon traditional backsighting-based techniques.

The method can be performed using a 3D survey apparatus, wherein the 3D survey apparatus can include a laser tracker, a total station (TS), and/or any other survey apparatus, embodiments, variations, and examples of which are described in relation to Section 3 above. The 3D survey apparatus can be coupled to a mobile platform, but can alternatively be fixed, movable by an operator, and/or any other configuration. The method can be performed autonomously, with a human in the loop, and/or any other way.

The method can be performed before construction (e.g., solar array construction), during construction, after construction, and/or at any other time. In a first example, surveying a site to characterize terrain topography before deploying construction equipment can occur before construction (e.g., solar array construction). An example is shown in FIGS. 5A-5C. In a second example, during construction can involve guiding autonomous deployment of solar array component (e.g., posts, brackets, solar modules) with real-time position reference. In a third example, after construction can include periodic inspection and maintenance to verify modules remain within tolerances as terrain evolves over the lifetime of the array (e.g., erosion/settlement on convex uphill regions).

The method can be performed for surveying, machine control, land grading, pile driving, line painting on pavement, any activity requiring localization of an external sensor in a global coordinate system (e.g., for automated tasks), and/or any other suitable activities.

The method can include an initial calibration stage (e.g., including acquiring a first set of 3D data points of a measurement object; acquiring a second set of 3D data points using a position sensor; optionally, synchronizing the first and second sets of 3D data points; and estimating a pose of the 3D survey apparatus, etc.) which functions to calibrate the pose of the 3D survey apparatus in a global reference frame, and an installation stage (e.g., determining a position of a mobile platform based on the estimated pose of the 3D survey apparatus, installing solar modules, and/or any other installation operations).

The method can preferably achieve better spatial accuracy than traditional methods involving position sensors, but can additionally and/or alternatively be otherwise performed. The method can preferably achieve less than 1.5 cm absolute spatial accuracy, but can alternatively achieve less than 1 cm, less than 5 cm, less than 10 cm, or any value therebetween of spatial accuracy. The method can preferably achieve less than 6 cm vertical spatial accuracy, but can alternatively achieve less than 5 cm, less than 10 cm, between 10-20 cm or any range or value therebetween, or any other vertical spatial accuracy.

Embodiments of the method can include detecting sensor errors (e.g., sensor dropout) in coordination with performing other portions of the methods described, but can alternatively not include detecting sensor errors. The detecting sensor errors preferably occurs continuously, but can alternatively occur during select steps of the method.

In an example, sensor errors can occur at any step of data collection (e.g., acquiring measurements of a measurement object, acquiring measurements using a position sensor, synchronizing measurements, etc.) and/or any other step.

In variations, The sensor errors (e.g., periods during which a sensors loses signal) can include one or more of: loss of line-of-sight (e.g., of a laser beam to a measurement object); loss of satellite connection (e.g., GPS, RTK base station link, etc.); communication loss (e.g., Wi-Fi transmission failure, packet loss, cable disconnection, etc.); measurement object obscured (e.g., by a person, vehicle, equipment, dust, fog, rain, condensation, etc.); instrument reset; power interruption; physical disruption (e.g., change to fixed spatial offset between prism and INS); error diagnostic status (e.g., RTK fix status, reported uncertainty, etc.); latency (e.g., measurement latency exceeding an upper bound); and/or any other errors.

Detecting sensor errors can trigger a notification (e.g., to a user), exclusion from the measurement dataset, exclusion from synchronization, exclusion from pose estimation, exclusion from optimization, flagging and/or labelling associated data, and/or any other actions.

### 4.1 Method—Data Point Acquisition Without Reliance Upon GCPs

Acquiring a first set of 3D data points of a measurement object S100 functions to measure a high-precision position of the measurement object in the 3D survey apparatus's local coordinate system (e.g., without reliance upon traditional GCP/backsighting-based techniques. As such, acquiring a first set of 3D data points of a measurement object S100 preferably does not include using a GCP, manual leveling over a benchmark, backsighting, and/or any other similar methods. Acquiring a first set of 3D data points of a measurement object S100 is preferably performed by the 3D survey apparatus (e.g., a total station), embodiments, variations, and examples of which are described above, but can additionally and/or alternatively be otherwise performed.

A 3D data point in the first set of 3D data points preferably includes measurements of relative location and orientation of the measurement object in the internal coordinate frame of the 3D survey apparatus, but can additionally and/or alternatively include any other suitable measurements. The internal coordinate frame preferably includes spherical coordinates (e.g., distance, r; vertical or polar angle, φ; horizontal angle or azimuthal angle, θ), but can additionally and/or alternatively include any other suitable coordinate system.

The 3D data point in the first set of 3D data points can be transformed in relation to Step S110, by applying a cartesian to the first set of 3D data points (e.g., for the purpose of an optimization). However, as described in more detail, one or more additional transformations can be performed.

The spatial relationship between the points is preferably precise within 1 mm and does not have compounding drift. The set of 3D points preferably has a constant (e.g., not time-varying) uncertainty in absolute world position. The measurements of relative location and orientation can include 3-6 degrees of freedom (DOF), more than 6 DOF, and/or any other DOF.

In a specific example, the set of 3D data points associated with the laser tracker local coordinates can be treated as if it is attached to a single rigid body. In the specific example, any errors in the estimation of the total station pose in global coordinates can affect the global position of the resulting array of points, not the relative positions between them. In the deployment of a solar module in an array, this error can be acceptable. In some cases, in order to achieve the tolerances needed for the placement of the posts, brackets, solar modules, and/or any other components, as described herein, the relationship between 3D points can be highly accurate, while the accuracy of the global location of the points is not as important.

Acquiring a first set of 3D data points of a measurement object S100 preferably includes a plurality of 3D data points measuring a plurality of positions of the measurement object (e.g., a trajectory of the measurement object), but can alternatively include a plurality of 3D data points measuring substantially the same position of the measurement object.

In a variant, acquiring a first set of 3D data points of a measurement object S100 can include: directing a laser beam at the measurement object; calculating the distance r from time-of-flight of the laser beam; measuring the azimuthal angle of the laser beam; and measuring the polar angle of the laser beam.

During acquiring a first set of 3D data points of a measurement object S100, the measurement object can concurrently traverse a trajectory, but can alternatively remain stationary. The trajectory can be predetermined, be based on a plan (e.g., a planned array configuration, a planned installation configuration, a planned, survey trajectory, etc.), and/or any other basis. In an example, acquiring a first set of 3D data points of a measurement object S100 can include the total station sampling measurements continuously as the measurement object coupled to the mobile platform traverses a trajectory.

Acquiring a first set of 3D data points of a measurement object S100 preferably includes the 3D survey apparatus being stationary with a fixed pose (e.g., fixed at a single position) for the duration of the measurement, but can additionally and/or alternatively be otherwise performed. In an example, acquiring a first set of 3D data points of a measurement object S100 can involve the 3D survey apparatus being moved and localized at other positions for separate calibration sessions, but calibration preferably localizes the 3D survey apparatus to a single position. In variants in which the 3D survey apparatus is mounted to a mobile platform and/or end effectors of a mobile platform, the mobile platform and/or its end effectors are preferably stationary, but can additionally and/or alternatively be otherwise positioned or moved (e.g., actuated).

Acquiring a first set of 3D data points of a measurement object S100 can include each 3D data point in the set of 3D data points being preferably timestamped by a first clock (e.g., the internal clock of the total station, a clock coupled to the 3D survey apparatus, etc.), but can additionally and/or alternatively be otherwise timestamped.

The first clock can be unsynchronized to the measurement object, the position sensor, the mobile platform, and/or any other component. Alternatively, the first clock can be synchronized to the position sensor, the mobile platform, the measurement object, a remote processor (e.g., at a user device), and/or any other component.

Acquiring a first set of 3D data points of a measurement object S100 can include the 3D survey apparatus measuring the position of the measurement object at a sampling rate between 8-10 Hz, between 1-20 Hz, up to 50 Hz, and/or any other sampling rate.

Acquiring a first set of 3D data points of a measurement object S100 can include transmitting the first set of 3D data points to a user device, a remote processor, a processor at the mobile platform, and/or any other device or processor. Alternatively, the first set of 3D data points can be stored and/or processed at a processing system arranged on the total station. The first set of 3D data points can be transmitted with a frequency between 2-20 Hz, 10-50 Hz, or 10-100 Hz or any range or value therebetween (e.g., 10 Hz). The frequency can alternatively be less than 2 Hz or greater than 100 Hz.

Acquiring a first set of 3D data points of a measurement object S100 can include transmitting the first set of 3D data points over Wi-Fi, UWB, Bluetooth, a wired connection (e.g., a serial cable), and/or any other transmission method. In an example, acquiring a first set of 3D data points of a measurement object S100 can be transmitted over Wi-Fi at a frequency of 10 Hz.

Acquiring a first set of 3D data points of a measurement object S100 can include transmitting the first set of 3D data points concurrently with sampling, with a latency after sampling (e.g., 0.1 ms-1 second, 1 second-10 seconds, and/or any value therebetween), after sampling a packet (e.g., after sampling at a stationary location of the mobile platform, after sampling a predetermined number of samples at a location in the trajectory, etc.), and/or any other timing.

However, the acquiring a first set of 3D data points of a measurement object S100 may be otherwise performed.

### 4.2 Method—Acquiring Additional 3D Data Points

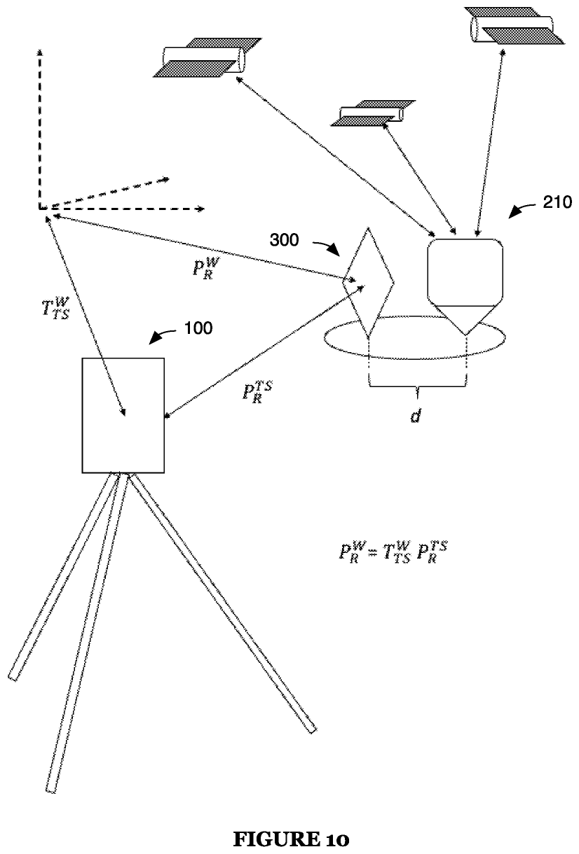

Acquiring a second set of 3D data points using a position sensor S200 functions to measure position and/or trajectory of the position sensor in a global coordinate frame. In examples, acquiring a second set of 3D data points using a position sensor S200 can measure position and/or trajectory of the position sensor in a global coordinate frame, wherein the second set of 3D data points measured in the global coordinate frame can enable a homogenous transform relating the local coordinate frame of the first set of 3D data points to a world coordinate frame (e.g., as shown in FIG. 10).

A 3D data point in the second set of 3D data points preferably includes a location in a geodetic/world coordinate frame, but can additionally and/or alternatively be otherwise located. Acquiring a second set of 3D data points using a position sensor S200 preferably includes latitude (e.g., the angular position north/south of the equator, ranging from \−90° to \+90°), longitude (e.g., the angular position north/south of the equator, ranging from \−90° to \+90°), and altitude (e.g., height above a reference geodetic ellipsoid), but can additionally and/or alternatively include any other suitable data points.

In examples, the geodetic measurement (e.g., including latitude, longitude, and altitude) is based on a curvilinear coordinate frame. In a variant, the geodetic measurement can be converted into a Cartesian frame (e.g., East-North-Up, Earth-Centered Earth-Fixed, and/or any other frame). Acquiring a second set of 3D data points using a position sensor S200 is preferably performed concurrently, contemporaneously, or iteratively with S100, but can alternatively be performed before S100 or after S100.

Acquiring a second set of 3D data points using a position sensor S200, the mobile platform preferably traverses a trajectory, but can alternatively remain stationary. In a variant, acquiring a second set of 3D data points using a position sensor S200 can be performed wherein the mobile platform can traverse a trajectory including pausing to remain stationary at a set of locations on the trajectory. The mobile platform preferably traverses the trajectory autonomously, but can alternatively traverse the trajectory semi-autonomously, as controlled by an operator, and/or any other way.

The trajectory can be predetermined (e.g., by an installation plan, by an array plan, by a surveying plan, as defined by an operator, etc.), not predetermined, determined by an operator, and/or any other trajectory determination method. In a first variant, acquiring a second set of 3D data points using a position sensor S200 can be performed wherein an operator can define a destination and/or parameter set, and the mobile platform can autonomously execute the destination or parameter set. In a second variant, acquiring a second set of 3D data points using a position sensor S200 can be performed wherein an operator can manually control the position and/or trajectory of the mobile platform.

In relation to performing step S200, the position sensor(s) used to perform Step S200 can include an inertial navigation system (INS), GPS, INS and GPS, INS and GPS with RTK, and/or any other position sensor. The inertial navigation system (INS) can measure inertia (e.g., acceleration and rotation) and estimate displacement direction and/or distance. The inertial navigation system (INS) can have unbounded compounding drift over time (e.g., growing error, not constant error). GPS can have an accuracy of 5 m via triangulation of at least 3 GPS satellites. GPS can be constrained by a line of sight to satellites (e.g., areas with tree cover, tall or closely-packed structures, or other obstructions can introduce additional error). INS and GPS can have an accuracy of 1.5 m, less than 5 m, and/or any other accuracy. INS and GPS with RTK can have an accuracy of 1.5 cm per point, but with non-constant error (e.g., drift) up to 1.5 cm per point that can compound over a series of measurement.

For performing Step S200, the position sensor is preferably mounted on the mobile platform (e.g., on an end effector, on a chassis of the mobile platform, on a stationary arm of the mobile platform, etc.), but can alternatively be arranged near the mobile platform, external to the mobile platform, and/or any other location. The position sensor is preferably arranged statically relative to the measurement object, but can alternatively be mounted.

The position sensor is preferably arranged at a known distance relative to the measurement object, but can alternatively be arranged at a known distance from the mobile platform, at a calculable relative location to the measurement object, and/or any other arrangement. In a first variant, acquiring a second set of 3D data points using a position sensor S200 can involve the measurement object being arranged on a mobile platform with a fixed and known spatial offset to a position sensor, which can be arranged on an end effector of the mobile platform. In a specific example, acquiring a second set of 3D data points using a position sensor S200 can include a calibration step for the spatial offset to account for differences in as-built hardware and/or drive in relative position over time (e.g., due to vibration and use).

Acquiring a second set of 3D data points using a position sensor S200 can have an output sampling rate that is preferably between 20-100 Hz or any range or value therebetween. The output sampling rate can alternatively be less than 20 Hz or more than 100 Hz.

Acquiring a second set of 3D data points using a position sensor S200 preferably includes timestamping the second set of 3D data points by a second clock (e.g., the internal clock of the position sensor, a clock coupled to the measurement object, a clock coupled to the mobile platform, etc.), but can additionally and/or alternatively be otherwise timestamped. The second clock is preferably not synchronized with the first clock and/or the mobile platform, but can alternatively be synchronized with the first clock and/or the mobile platform.

Acquiring a second set of 3D data points using a position sensor S200 can be measured at a sampling rate of 40 Hz, 10-60 Hz, 10-100 Hz, 20-200 Hz, 50-500 Hz, and/or any value therebetween.

Acquiring a second set of 3D data points using a position sensor S200 preferably transmits the second set of 3D data points to a processor arranged on the mobile platform, but can alternatively transmit the second set of 3D data points to a remote processor, a user device, and/or any other device. The second set of 3D points is preferably transmitted over a wired connection (e.g., a serial cable), but can alternatively be transmitted using Wi-Fi, UWB, Bluetooth, and/or any other transmission method. therebetween. In an example, acquiring a second set of 3D data points using a position sensor S200 can transmit the position sensor measurements (e.g., over a serial cable) at a frequency of 40 Hz, 30-50 Hz, 40-60 Hz, 40-100 Hz, 20-200 Hz, and/or any value therebetween.

Acquiring a second set of 3D data points using a position sensor S200 can include transmitting the second set of 3D data points concurrently with sampling, with a latency after sampling (e.g., 0.1 ms-1 second, 1 second-10 seconds, and/or any value therebetween), after sampling a packet (e.g., after sampling at a stationary location of the mobile platform, after sampling a predetermined number of samples at a location in the trajectory, etc.), and/or any other transmission timing.

However, the acquiring a second set of 3D data points using a position sensor S200 may be otherwise configured.

### 4.3 Method—Optional Synchronization of First and Additional Sets of 3D Datapoints

The method can optionally include synchronizing the first and second sets of 3D data points S300, which functions to pair measurements from the 3D survey apparatus and the position sensor which were acquired with different clocks and/or different sampling rates.

Synchronizing the first and second sets of 3D data points S300 is preferably performed when the first clock (e.g., the internal clock of the 3D survey apparatus) is not synchronized with the second clock (e.g., the internal clock of the position sensor), but can additionally and/or alternatively be otherwise performed. In examples, because of the mismatch in clocks and sampling rates, a natural one-to-one correspondence between a 3D apparatus measurement and a position sensor measurement may not exist. Synchronizing the first and second sets of 3D data points can function to pair measurements from the 3D survey apparatus and the position sensor to estimate the 3D survey apparatus pose. In examples, synchronizing the first and second sets of 3D data points S300 when the first clock is not synchronized with the second clock can be when components (e.g., the total station) do not support protocols that enable synchronizing the clock to an external clock (e.g., using network time protocol).

Synchronizing the first and second sets of 3D data points S300 preferably does not occur for periods of sensor errors (e.g., loss of line-of-sight to the 3D survey apparatus, loss of position sensor signal, error in diagnostic status, etc.); detected inaccurate position sensor measurements; and/or detected latency errors (e.g., exceeding an upper bound of 3D survey apparatus measurement latency), but can additionally and/or alternatively be otherwise performed.

In a variant, detecting inaccurate position sensor measurements can be based on motion sensor measurements (e.g., exceeding a threshold velocity and/or acceleration metric). In a variant, detecting inaccurate position sensor measurements can be based on machine activity states (e.g., self-induced vibration from driving a post into the ground).

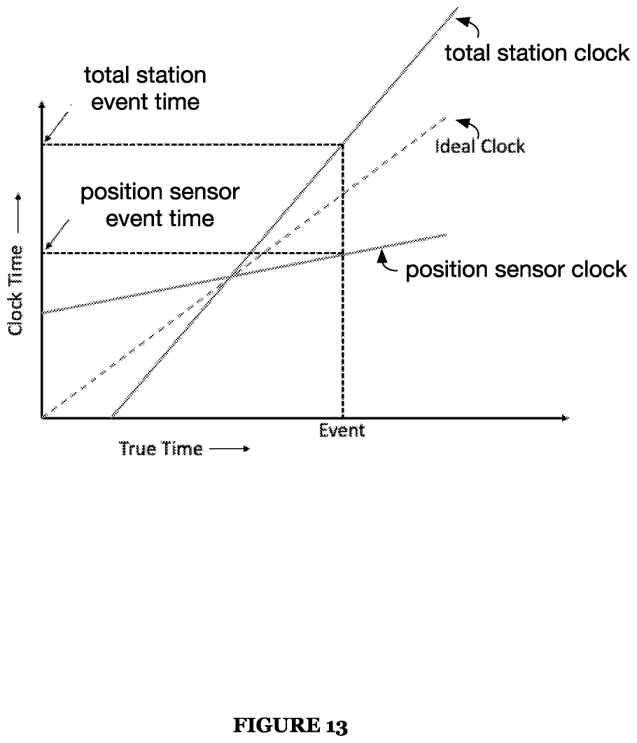

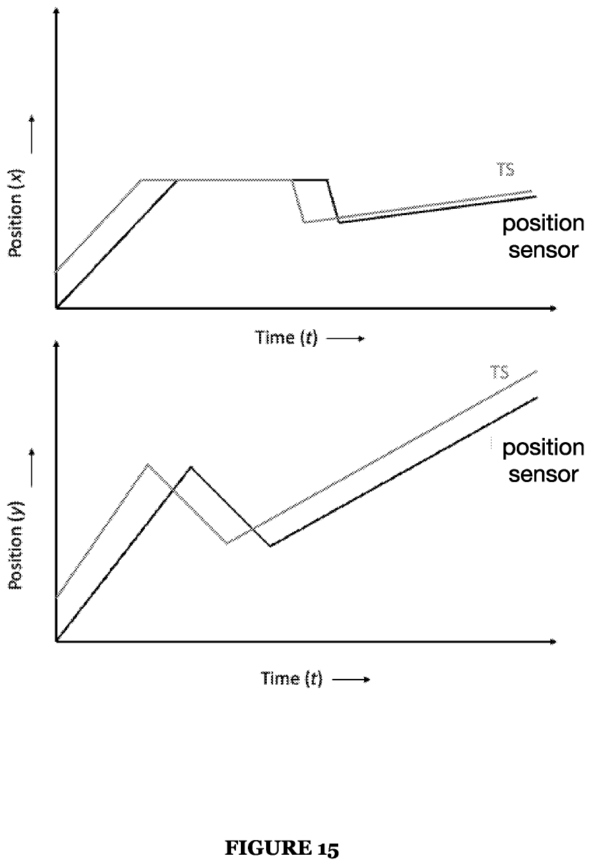

In examples, synchronizing the first and second sets of 3D data points S300 can include modeling the relationship between the first clock and the second clock as a linear equation t₁=m*t₂+b, where m is the clock drift (e.g., ratio of the length of a second in the first clock to the length of a second in the second clock) and bis the clock skew (e.g., the offset between the zero-time reference of the first clock and the zero-time reference of the second clock). An example of clock synchronization of measurements is shown in FIG. 13. An example of incorrect clock skew is shown in FIG. 15. In the case of incorrect clock skew, graphs of X and Y positions as a function of time from different sensors may possess the same shape, but be offset along the time axis. An incorrect estimate of clock skew is the simplest case to observe. In the case of incorrect clock drift or total station pose, the error would be much more difficult to quantify by looking at the graph. As an example, error in clock drift could cause one graph to be shrunk along the time axis with respect to the other.

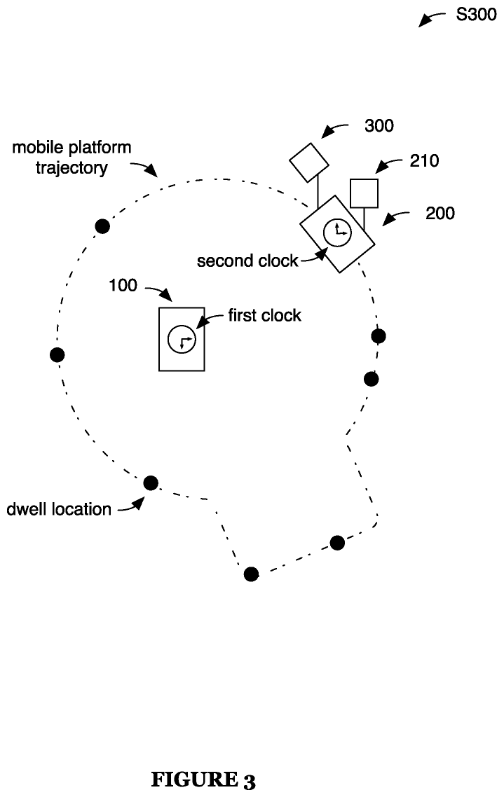

In a first variant, synchronizing the first and second sets of 3D data points S300 can include: the mobile platform pausing at a plurality of stationary dwell locations (e.g., on a trajectory); the 3D survey apparatus acquiring a cluster of measurements at each dwell location; the position sensor acquiring a corresponding cluster of measurements at each dwell location; and computing cluster centroids for each sensor and using them as paired measurement points (e.g., as shown in FIG. 3). Synchronizing the first and second sets of 3D data points S300 preferably includes at least 2 clusters being collected (e.g., as the minimum to solve a 6-degrees-of-freedom problem), but can alternatively include collecting 3, 4, 5, 6, 7, 2-6, 2-10, 10-20, 20-50, clusters, or any value therebetween. A stationary state is preferably detected using velocity reported by the position sensor, but can alternatively be detected by clustering points from two sensors (e.g., with different data rates and noise profiles).

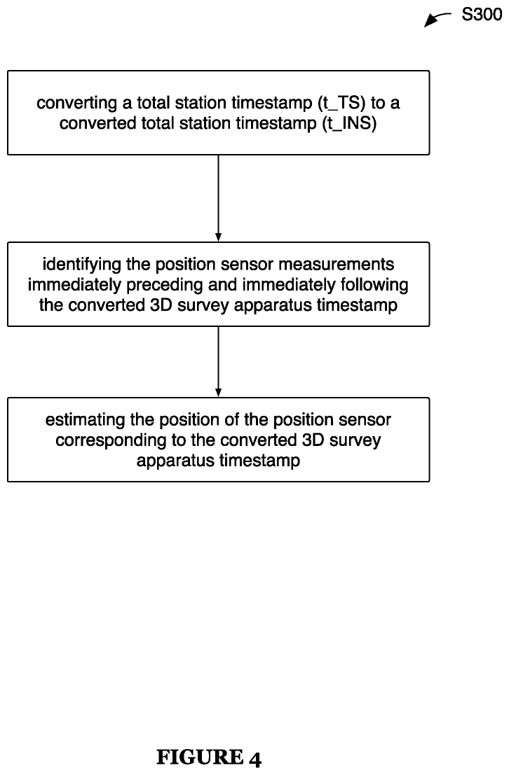

In a second variant, synchronizing the first and second sets of 3D data points S300 can include: converting the 3D survey apparatus timestamp (e.g., the total station timestamp) to a converted 3D survey apparatus timestamp (e.g., t_{INS}, converted total station timestamp; e.g., referencing the INS clock); identifying the position sensor measurements immediately preceding and immediately following the converted 3D survey apparatus timestamp; and estimating the position of the position sensor corresponding to the converted 3D survey apparatus timestamp (e.g., as shown in FIG. 4).

Converting the 3D survey apparatus timestamp to a converted 3D survey apparatus timestamp can include converting a 3D survey apparatus timestamp to the position sensor clock reference, using the equation t_{INS} =m *t_{TS} +b, wherein t_{INS}represents the position sensor clock time and t_{TS}represents the 3D survey apparatus clock time. Initial estimates of m and b can be obtained by linear least-squares regression of each sensor clock against a master clock (e.g., the mobile platform clock, robot clock, etc.), then combined algebraically. The constants m and b are preferably refined jointly with the pose of the 3D survey apparatus in the same non-linear least-squares optimization performed when estimating the pose of the 3D survey apparatus. The constants m and b are preferably refined jointly with the pose of the 3D survey apparatus in the same non-linear least-squares optimization performed when estimating the pose of the 3D survey apparatus.

According to the second variant, after initial estimation, m and b are preferably periodically re-estimated with the pose of the 3D survey apparatus held fixed (e.g., at intervals of 1-10 seconds, 10-60 seconds, 1-5 minutes, 1-20 minutes, 20-50 minutes, 50-100 minutes, and/or any value therebetween), but can additionally and/or alternatively be otherwise re-estimated.

Re-estimation of clock parameters functions to compensate for position sensor drift bias, which can corrupt clock parameter estimates over extended operation, and prevent small errors in clock drift from compounding into large position errors after timestamp conversion and interpolation. The pose of the 3D survey apparatus is preferably not updated during re-estimation of clock parameters, but can alternatively be updated. In examples, updating the pose of the 3D survey apparatus can introduce relative errors between measurements made before the pose was updated.

Re-estimation of clock parameters is preferably gated on fulfilment of a minimum criterion, such as minimum elapsed time, minimum trajectory length, absence of sensor errors periods, minimum position estimates (e.g., of the measurement object, of the position sensor, etc.). Re-estimation of clock parameters is preferably triggered by a periodic schedule, a user input (e.g., from an operator), a sensor reset event, sensor connection loss, unusual sensor latency (e.g., exceeding a predetermined threshold of latent time), and/or any other suitable event. Re-estimation of clock parameters is preferably not triggered when elapsed time and/or trajectory length from sensors (e.g., the position sensor and the 3D survey apparatus, the mobile platform and the 3D survey apparatus, the 3D survey apparatus and the mobile platform odometry, etc.) conflict (e.g., the difference in measurements exceeds a predetermined threshold).

Step S300 can optionally include identifying the position sensor measurements immediately preceding and immediately following the converted 3D survey apparatus timestamp (e.g., the two bracketing position sensor measurements), which functions to identify position sensor measurements to use to interpolate the position of the position sensor at the converted 3D survey apparatus timestamp (e.g., the timestamp of the 3D survey apparatus measurement converted to the position sensor clock reference).

Alternatively, identifying the position sensor measurements immediately preceding and immediately following the converted 3D survey apparatus timestamp can use the position sensor measurement at the closest timestamp to the converted 3D survey apparatus timestamp (e.g., nearest-neighbor pairing). In an example, at a platform speed of 7 m/s with the position sensor at 100 Hz, nearest-neighbor pairing without interpolation can introduce up to 35 mm of error; linear interpolation can reduce the error to below an acceptable threshold (e.g., below 20 mm). However, the identifying the position sensor measurements immediately preceding and immediately following the converted 3D survey apparatus timestamp (e.g., the two bracketing position sensor measurements) may be otherwise configured.

Step 300 can include estimating the position of the position sensor corresponding to the converted 3D survey apparatus timestamp. Estimating the position of the position sensor corresponding to the converted 3D survey apparatus timestamp (e.g., the timestamp of the 3D survey apparatus measurement converted to the position sensor clock reference) functions to estimate a position of the position sensor at substantially the same timestamp as the 3D survey apparatus measurement timestamp. Estimating the position of the position sensor corresponding to the converted 3D survey apparatus timestamp (e.g., the timestamp of the 3D survey apparatus measurement converted to the position sensor clock reference) is preferably in global coordinates, but can alternatively be in relative coordinates to the 3D survey apparatus.

Estimating the position of the position sensor corresponding to the converted 3D survey apparatus timestamp (e.g., the timestamp of the 3D survey apparatus measurement converted to the position sensor clock reference) preferably interpolates the position of the position sensor using two position sensor measurements, but can alternatively extrapolate the position of the position sensor from a single position sensor measurement, or use a position measurement temporally close and/or within a threshold of timesteps to the 3D apparatus timestamp (e.g., in position sensor clock reference).

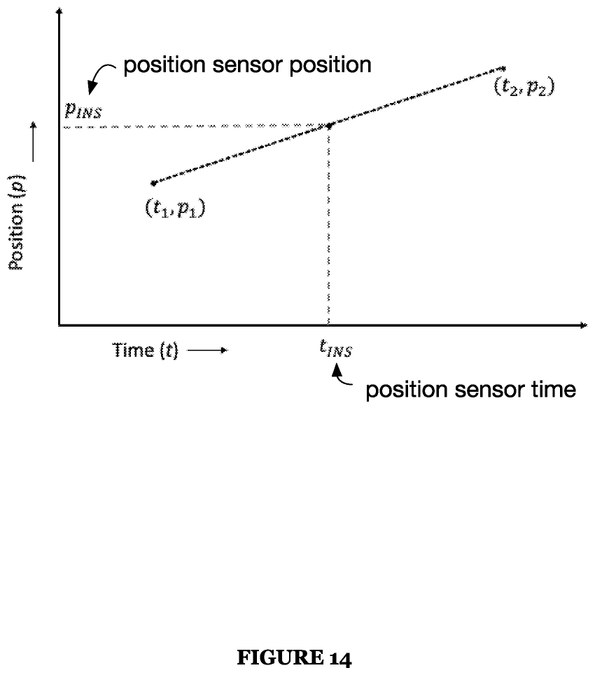

Estimating the position of the position sensor corresponding to the converted 3D survey apparatus timestamp (e.g., the timestamp of the 3D survey apparatus measurement converted to the position sensor clock reference) preferably uses linear interpolation (e.g., as shown in FIG. 14), but can alternatively use polynomial interpolation and/or any other type of interpolation. In an example, estimating the position of the position sensor corresponding to the converted 3D survey apparatus timestamp (e.g., the timestamp of the 3D survey apparatus measurement converted to the position sensor clock reference) can assume constant velocity between the two bracketing position sensor measurements and use linear interpolation to determine the estimated position.

In an example, estimating the position of the position sensor corresponding to the converted 3D survey apparatus timestamp (e.g., the timestamp of the 3D survey apparatus measurement converted to the position sensor clock reference) can use extrapolation when clock parameters are incorrect, different sensor's clock parameters conflict, and/or any other conflict.

However, the estimating the position of the position sensor corresponding to the converted 3D survey apparatus timestamp (e.g., the timestamp of the 3D survey apparatus measurement converted to the position sensor clock reference) may be otherwise configured. Converting the 3D survey apparatus timestamp (e.g., the total station timestamp) to a converted 3D survey apparatus timestamp (e.g., t_INS, converted total station timestamp; e.g., referencing the INS clock) may be otherwise configured. Synchronizing the first and second sets of 3D data points S300 may also be otherwise configured.

### 4.4 Method—Estimating a Pose of the 3D Survey Apparatus

Estimating a pose of the 3D survey apparatus S400 functions to calibrate the pose of the 3D survey apparatus in global coordinates. In an example, estimating a pose of the 3D survey apparatus S400 can use the calibrated (e.g., estimated) pose of the 3D survey apparatus to transform the local (e.g., relatively measurements of the 3D survey apparatus into global coordinates with accuracy sufficient for solar array deployment (e.g., less than 20 mm).

Estimating a pose of the 3D survey apparatus S400 is preferably based at least in part on the position of the position sensor (e.g., as determined in S200 and/or the estimated position as determined in S300) and the relative position of the position sensor and the measurement object, but can additionally and/or alternatively be otherwise based. In an example, estimating a pose of the 3D survey apparatus S400 can include adding a known distance between the position sensor and the measurement object to the estimated position of the position sensor. Synchronizing the first and second sets of 3D data preferably does not occur for periods of sensor errors (e.g., loss of line-of-sight to the 3D survey apparatus, loss of position sensor signal, error in diagnostic status, etc.); detected inaccurate position sensor measurements; and/or detected latency errors (e.g., exceeding an upper bound of 3D survey apparatus measurement latency).

Estimating a pose of the 3D survey apparatus S400 is preferably performed after acquiring the first and second sets of 3D data points and/or after synchronizing the first and second sets of 3D data points, but can additionally and/or alternatively be otherwise performed.

Estimating a pose of the 3D survey apparatus S400 can be performed using a processor (e.g., the mobile platform processing system, a remote processor, and/or any other processor).

Estimating a pose of the 3D survey apparatus S400 preferably includes a position in the global coordinate frame and an orientation (e.g., six degrees of freedom in which three degrees of freedom account for the position of the total station, and three degrees of freedom account for the orientation), but can alternatively include a position in a local coordinate frame and an orientation.

The pose can be as a 4×4 homogenous transformation matrix

$$( e . g . , {T}_{W}^{TS} )$$

for optimization, but can alternatively be parameterized in a non-homogenous transformation matrix and/or a matrix of any suitable dimension. In an example, estimating a pose of the 3D survey apparatus S400 can be vectorized by separating the position and orientation components of the pose. In this case, the position can be given by a first three vector components, X, Y, and Z, and the orientation can be given by a second three vector components as an axis-angle parameterization.

The matrix is preferably vectorized as three translational components (e.g., X, Y, and Z) and three rotational components, but can additionally and/or alternatively be otherwise vectorized. In a variant, estimating a pose of the 3D survey apparatus S400 can be shown in axis-angle representation. In an example of the variant, the axis-angle can form a continuous vector space, which can be added and subtracted without producing invalid orientations.

Estimating a pose of the 3D survey apparatus S400 can be based on one or more sets of 3D data points (e.g., measurements, datasets) measured from the total station (e.g., in a local coordinate frame, in a spherical coordinate frame, etc.) and one or more datasets measured from a position sensor (e.g., in a global coordinate frame).

The one or more sets of 3D data points and one or more datasets are preferably measured in S100, but can alternatively be pre-loaded, measured after an initial calibration, and/or otherwise measured. The first set of 3D datapoints preferably includes spherical coordinates measured from the total station. Estimating a pose of the 3D survey apparatus S400 preferably includes a second set of 3D datapoints measured from the position sensor including global coordinate positions (e.g., (e.g., latitude, longitude, altitude, or a local Cartesian equivalent).

In a variant, estimating a pose of the 3D survey apparatus S400 can include converting to a different coordinate frame. In an example of the variant, estimating a pose of the 3D survey apparatus S400 can convert a set of 3D datapoints measured by the total station in spherical coordinates to Cartesian coordinates.

In a variant, estimating a pose of the 3D survey apparatus S400 can include transforming (e.g., translating, rotating, and/or any other transformation) a set of 3D points. In an example of the variant, estimating a pose of the 3D survey apparatus S400 can include wherein a dataset measured from a position sensor can be translated using the known spatial offset between the position sensor and the measurement object.

Estimating a pose of the 3D survey apparatus S400 can be based on one or more sets of 3D data points (e.g., measurements, datasets) measured from the total station (e.g., in a local coordinate frame, in a spherical coordinate frame, etc.) and one or more datasets measured from a position sensor (e.g., in a global coordinate frame), wherein a measurement from the total station is preferably paired with a measurement from the position sensor, but can additionally and/or alternatively be otherwise paired.

The paired measurements preferably correspond with the same moment in time, but can alternatively correspond with an index, a timestep, and/or any other suitable parameter. The paired measurement is preferably determined during synchronization of the first and second sets of 3D datapoints, but can alternatively be a raw position sensor measurement paired with a raw total station measurement. In a first example, estimating a pose of the 3D survey apparatus S400 can include a total station measurement paired with an interpolated position sensor measurement at the same timestamp. In a second example, estimating a pose of the 3D survey apparatus S400 can pair a total station measurement with a position sensor measurement at the same timestep.

Estimating a pose of the 3D survey apparatus S400 preferably includes using at least 2 pairs of measurements, but can alternatively use 3, 4, 5, 6, 7, 8, 9-20, 20-50, 50-100, and/or any value therebetween.

Estimating a pose of the 3D survey apparatus S400 can include determining an initial pose estimate of the total station. In a variant, the translational component of the initial pose estimate can be the first position sensor measurement (e.g., the first 3D datapoint of the second set of 3D datapoints). In a variant, the orientation of the initial pose estimate can be identity, level, and/or a default orientation.

Estimating a pose of the 3D survey apparatus S400 can include parametrizing the estimated pose as a 6-element vector with 3 translational components and 3 rotational components (e.g., in axis-angle representation).

Estimating a pose of the 3D survey apparatus S400 can include computing a residual for each paired measurement (e.g., paired measurements from the first and second sets of 3D data points). Computing a residual for each paired measurement (e.g., paired measurements from the first and second sets of 3D data points) functions to calculate the difference between two independent estimates of the position of the measurement object.

Computing a residual for each paired measurement preferably includes calculating the residual as a function of the current pose estimate (e.g., the initial pose estimate for the first residual computation, the new pose if the pose estimate changed, etc.), but can alternatively include calculating a residual for paired cluster centroids (e.g., the centroid of a cluster of measurements). In a first variant, estimating a pose of the 3D survey apparatus S400 can be wherein the current pose estimate can be transformed into world coordinates and subtracted from the position sensor measurement. In a second variant, the position sensor measurement can be transformed and subtracted from the total station measurement.

The residual is preferably the difference between the estimated position of the measurement object and the position of the measurement object as determined by the 3D survey apparatus's measurement of the measurement object (e.g., the 3D survey apparatus's local coordinate measurement transformed into global coordinates), but can alternatively be the difference between the estimated position of the position sensor and the position of the position sensor as determined by the 3D survey apparatus's measurement of the measurement object, wherein a known difference between the position sensor and measurement object has been applied. In examples, if the pose and the clock parameters are perfectly estimated (e.g., in S300), the residual can be zero or small but nonzero due to position sensor noise and/or drift.

The residual can be preferably calculated after applying the estimated pose and clock parameters, but can alternatively be calculated after applying an estimated position parameter, clock parameter, pose parameter, and/or any other parameters.

The residual is preferably continuously monitored and/or recorded, but can alternatively be monitored and/or recorded periodically (e.g., at intervals of 1-10 seconds, 10-60 seconds, 1-5 minutes, 1-20 minutes, 20-50 minutes, 50-100 minutes, and/or any value therebetween), in response to user input, and/or in response to a new measurement session.

The residual is preferably reported (e.g., at a user interface, at an accessory, sent to a processing system, recorded, and/or any other reporting method), but can additionally and/or alternatively be otherwise reported.

Estimating a pose of the 3D survey apparatus S400 preferably triggers a warning and/or error state in response to exceeding a threshold residual or exceeding a threshold change (e.g., between a difference and a rolling average, between a difference and an average predetermined time period, between differences calculated at adjacent timesteps, etc.), but can additionally and/or alternatively be otherwise triggered. In a first example, estimating a pose of the 3D survey apparatus S400 can use a threshold that is predetermined (e.g., over 10 mm, over 20 mm, over 300 mm, and/or any value therebetween). In a second example, estimating a pose of the 3D survey apparatus S400 can use a threshold based on an average residual (e.g., an average of a sliding window of measurements). In a third example, estimating a pose of the 3D survey apparatus S400 can use a threshold change calculated between adjacent timesteps (e.g., more than a change of between 1-10 mm, 2 mm, 3 mm, between 1-200 mm, 5%, 10% , 100%, 110%, 1-100%).

Estimating a pose of the 3D survey apparatus S400 can include applying an optimization algorithm. The optimization algorithm functions to minimize the sum of squared residuals over all paired measurements. In a variant, when clock parameters m and b are jointly estimated (e.g., in a variant of S300), the optimization jointly minimizes over pose, m, and b, since the residuals are additionally and/or alternatively functions of m and b.

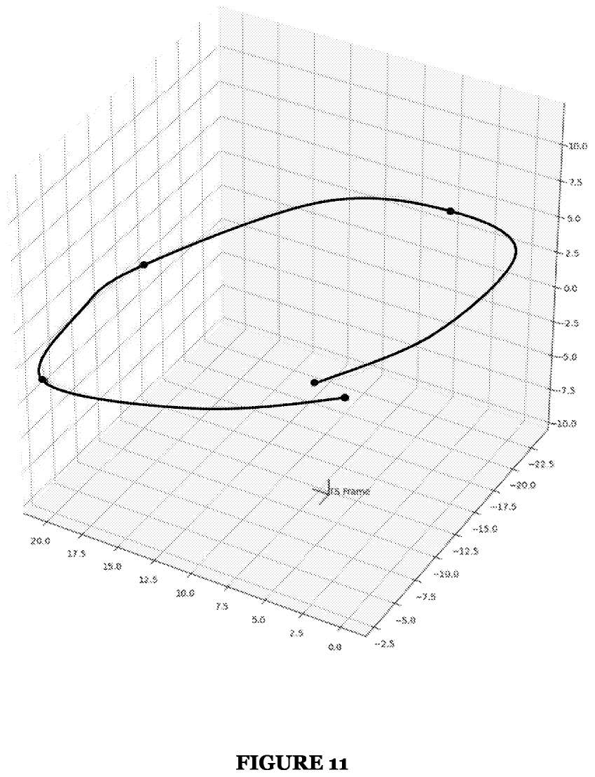

In some cases, to solve the one or more optimization schemes, the pose of the total station can be given 6 independent degrees of freedom. Three degrees of freedom can account for the position of the total station, and three degrees of freedom can account for the orientation. Performing an optimization of the pose with 6 degrees of freedom can use one or more data sets (e.g., the first and second sets of 3D data points), including a total of 6 or more degrees of freedom. In some cases, the optimization data set can have 3 degrees of freedom. In some cases, the optimization data set can have 6 degrees of freedom. In some cases, the optimization data set can include two sub data sets with 3 degrees of freedom (e.g., from the first and second sets of 3D data points). In some cases, the optimization data set can include at least two sub data sets, wherein each sub data set can include 3 degrees of freedom. An example of a data set with 3 degrees of freedom, such as a set of 3D data points in accordance with some embodiments, can be provided in FIG. 11.

Applying an optimization algorithm can include, in some cases, using two sets of 3D data points to solve the one or more optimization schemes. In some cases, one of the sets of 3D data points can include a set of positions measured by the total station. In some cases, one of the sets of 3D data points can include a set of positions measured by the INS-aided GPS sensor. In some cases, three or more sets of 3D data points can be used.

In some cases, applying an optimization algorithm can include using two data sets to solve the one or more optimization schemes, wherein the two data sets include a first set of 3D data points from the total station, and a second set of 3D data points from the INS-aided GPS sensor. In this case, the pose of the total station can be estimated by lining up the first set of 3D data points and the second set of 3D data points. In some embodiments, the first set of 3D data points and the second set of 3D data points can be fitted with a linear matrix equation. In some embodiments, the first set of 3D data points and the second set of 3D data points can be fitted with a non-linear function.

In some cases, one or more non-linear least-squares optimization methods can be used. In some cases, the non-linear least-squares optimization method involves an initial estimate of the pose of the total station, TTSW. Then, the points from the two sets of 3D data points can be paired, one INS-aided GPS point to one total station local coordinate point. The location of the set of 3D data points in total station laser local coordinates, total station Coordinates (TSC), can then be estimated in global coordinates, W, wherein

$${P}_{TSC}^{W} = {T}_{TS}^{W} {P}_{TSC}^{TS} .$$

difference, Δ, between total station local coordinates and position sensor coordinates (e.g., INS-aided GPS coordinates, INS Coordinates), can then be calculated between each of the paired points,

$$Δ = {P}_{◻}^{W} - {P}_{INSC}^{W} .$$

The difference values, Δ, become the residuals, wherein each is a function of the pose. In this case, the pose can be in the form of a 4×4 matrix, but in other cases can be in the form of any dimensioned matrix.

In some cases, the solution to the one or more non-linear least-squares optimization methods described herein is more conveniently expressed as a vector. In the case where the pose is given in the form of a 4×4 matrix, this can be vectorized by separating the position and orientation components of the pose. In this case, the position can be given by a first three vector components, X, Y, and Z, and the orientation can be given by a second three vector components as an axis-angle parameterization. The axis angle parameterization can be a continuous vector space, and unlike Euler angles, can be subtracted without making an invalid orientation. With the pose separated, the partial derivative of each residual can be taken with respect to each of the 6 vector components. This includes a complete non-linear least-squares function, which can be solved by a variety of algorithms. In one example, the non-linear least-squares function can be solved by the Levenberg-Marquadt algorithm.

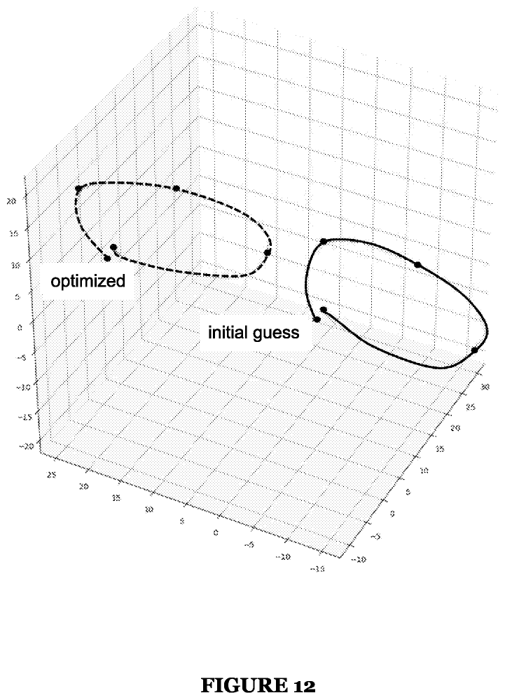

A example of the result of a non-linear least-squares optimization of two sets of 3D data points, described herein, is provided in FIG. 12. In FIG. 12, the initial guess location of the total station and the first set of 3D data points in TSC is shown as a solid line with point markers. The second set of 3D data points in INSC from the INS-aided GPS sensor is shown on the left. The resulting optimized 3D cluster transformed into global coordinates is also shown on the left as a dashed line with point markers. Note, in this case, the second set of 3D data points in INSC from the INS-aided GPS sensor and resulting optimized 3D cluster transformed into global coordinates were aligned well enough to appear nearly indistinguishable in the plot. In this case, a precision and accuracy of the optimized set of 3D data points of about 9 millimeters was achieved. In the deployment of a solar module in an array, described herein, a tolerance of 20 millimeters or less is suitable.

Estimating a pose of the 3D survey apparatus S400 can include applying an optimization algorithm, wherein the optimization can stop in response to meeting a stop condition. In a first variant, the stop condition can include the residuals for each measurement pair under a threshold, where the threshold can be predetermined (e.g., less than 10 mm, less than 20 mm, less than 30 mm, less than 50 mm, less than a value between 1-100 mm, etc.), defined by a user, and/or otherwise defined. In a second variant, the stop condition can include a threshold number of iterations. In a third variant, the stop condition can include a performance-based criterion (e.g., no improvement in the residuals for K consecutive iterations).

However, the estimating a pose of the 3D survey apparatus S400 may be otherwise configured.

### 4.5 Method—Determining Position of Mobile Platform Using Estimated 3D Surveyor Pose

The method can optionally include determining a position of the mobile platform based on an estimated pose of the 3D survey apparatus S500, which functions to use the estimated pose of the 3D survey apparatus to transform additional measurements from total station local coordinates to world coordinates, providing high-precision 3D positions for downstream tasks (e.g., solar array deployment).

Determining a position of the mobile platform based on an estimated pose of the 3D survey apparatus S500 is preferably performed by applying the homogeneous transform determined in S400

$$( e . g . , {P}_{R}^{W} = {T}_{W}^{TS} * {P}_{R}^{TS} )$$

to each new TS measurement

$$( e . g . , {P}_{R}^{TS} )$$

to obtain its world-frame position

$$( e . g . , {P}_{R}^{W} ) ,$$

but can additionally and/or alternatively be otherwise performed. An example is shown in FIG. 10.

Determining a position of the mobile platform based on an estimated pose of the 3D survey apparatus S500 preferably does not occur for periods of sensor errors (e.g., loss of line-of-sight to the 3D survey apparatus, loss of position sensor signal, etc.), but can additionally and/or alternatively be otherwise performed.

The accuracy of new 3D point positions is preferably no greater than 20 mm, no greater than 15 mm, no greater than 9 mm, but can alternatively be better than the accuracy of the position sensor alone.

The new 3D points can include positions of posts, brackets, solar modules, terrain surface features, and/or any other objects within the TS measurement range.

Determining a position of the mobile platform based on an estimated pose of the 3D survey apparatus S500 can result in a world-frame point cloud that preferably feeds into a computer program product that generates: post locations and driving depths; post tilt angles; bracket and module orientations; and robotic traversal paths for autonomous deployment, but can additionally and/or alternatively be otherwise used.

In a variant, determining a position of the mobile platform based on an estimated pose of the 3D survey apparatus S500 can include real-time position estimation by applying known clock parameters (m, b) to synchronize live TS and position sensor data, wherein a real-time position estimate can be computed at the higher data rate of the position sensor. The real-time position estimation functions to provide a continuous position feed to an operator display or for collision avoidance between autonomous vehicles; real-time estimates preferably use fused sensor data and may be less precise than post-processed estimates.

Determining a position of the mobile platform based on an estimated pose of the 3D survey apparatus S500 preferably occurs periodically (e.g., every 1-60 seconds, 1 minute-10 minutes, every 1-10 measurements, every 10-100 measurements, etc.), but can additionally and/or alternatively be otherwise performed.

Determining a position of the mobile platform based on an estimated pose of the 3D survey apparatus S500 preferably occurs after initial calibration of the 3D survey apparatus in global coordinates (e.g. estimating a pose of the 3D survey apparatus S400), but can additionally and/or alternatively be otherwise performed.

In a first variant, determining a position of the mobile platform based on an estimated pose of the 3D survey apparatus S500 can include computing the residual in real time using the new 3D data points. Computing the residual in real time using the new 3D data points preferably runs in the background during normal operation, but can alternatively occur as part of a re-calibration stage. Computing the residual in real time using the new 3D data points can include pairing each new total station measurement with its interpolated position in global coordinates. In examples, if the total station has not changed position and the clock parameters are accurate, then the live residuals can be small and consistent. However, a growing and/or large residual can indicate a total station disturbance and/or a clock parameter drift.

In a second variant, determining a position of the mobile platform based on an estimated pose of the 3D survey apparatus S500 can include creating new background localization solutions. Determining a position of the mobile platform based on an estimated pose of the 3D survey apparatus S500 can include estimating a background pose and/or a background clock solution (e.g., synchronizing different sets of data points respectively associated with different clocks) based on a trailing window (e.g., a set of most recent 3D data points).

Creating new background localization solutions can include comparing the background pose (e.g., the most recent pose) to the primary pose (e.g., the original calibrated pose solution) and/or comparing the background clock solution to the primary clock solution (e.g., the original calibrated clock relationship). In an example, if the background solution and the primary solution are substantially the same, then the primary solution is still accurate. However, if the background solution diverges from the primary solution, then it can be flagged as a disturbance and/or drift. In the example, divergence can be determined when the difference exceeds a threshold (e.g., more than a change of between 20 mm, 1-10 mm, 10-100 mm, 20-200 mm, 50 mm-5 m, 5%, 10%, 100%, 110%, 200%, 1000%, 100-5000%).

In a variant, determining a position of the mobile platform based on an estimated pose of the 3D survey apparatus S500 can involve combining measurements from the 3D survey apparatus and the position sensor (e.g., using a Kalman filter or similar) to produce position estimates. In an example of the variant, determining a position of the mobile platform based on an estimated pose of the 3D survey apparatus S500 can be performed at the data rate of the position sensor. In an example of the variant, determining a position of the mobile platform based on an estimated pose of the 3D survey apparatus S500 can be performed with accuracy approaching that of the 3D survey apparatus. In an example of the variant, determining a position of the mobile platform based on an estimated pose of the 3D survey apparatus S500 can be used for real-time machinery control, operator position display, and/or any other multi-robot collision avoidance.

In a variant, determining a position of the mobile platform based on an estimated pose of the 3D survey apparatus S500 can be performed by comparing synchronized TS and position sensor measurements over time, wherein the drift characteristics of the position sensor (e.g., magnitude, rate, directional bias) can be quantified.

In another variant, determining a position of the mobile platform based on an estimated pose of the 3D survey apparatus S500 can be performed by comparing TS measurement timestamps against robot clock timestamps, wherein systematic Wi-Fi transmission latency can be estimated.

However, the determining a position of the mobile platform based on an estimated pose of the 3D survey apparatus S500 may be otherwise configured.

### 4.6 Method—Deploying/Installing a Solar Array

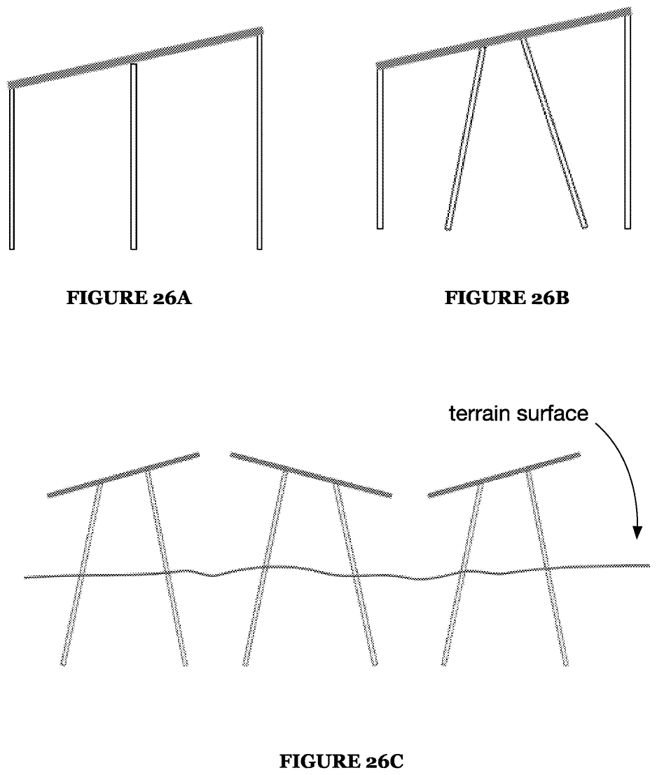

The method can optionally include deploying a solar array S600, which can be performed by the mobile platform (e.g., using the installation machinery). Deploying a solar array S600 can include receiving an array design, which functions to receive the array designs defining how the mobile platform installs the solar array. A solar array can include an assembly including one or more posts and one or more solar modules (e.g., as shown in FIGS. 26A-C)

The array design can include: density of solar modules, density of posts, locations of the posts, distance between posts, height of the posts, orientation of the solar modules, and/or distance between the solar modules. Receiving an array design can be predetermined, received by a user input, and/or any other method.

The array design can be received wirelessly (e.g., Wi-Fi, UWB, Bluetooth, etc.) or through a wired connection. The array design is preferably received by the mobile platform processing system, but can alternatively be received at an external processor and/or any other device.

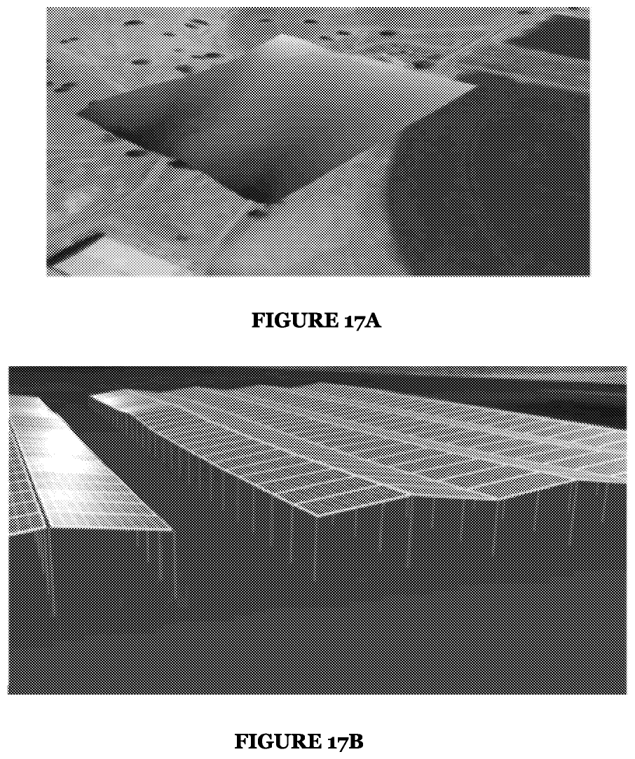

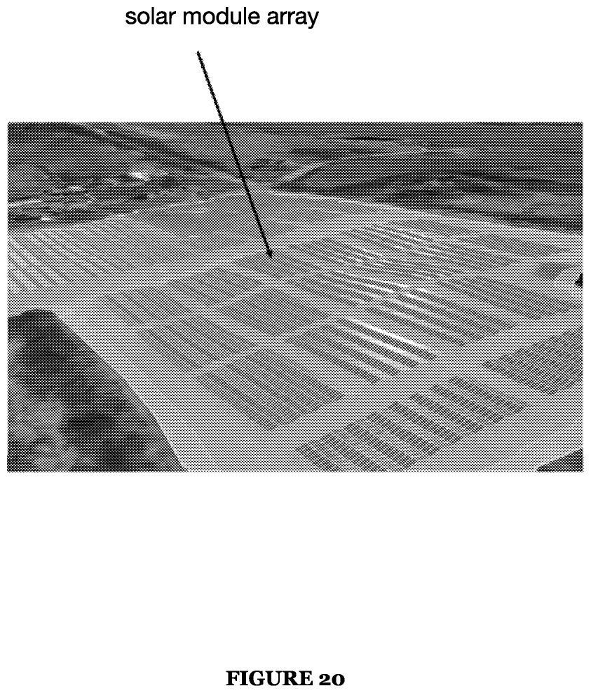

Receiving an array design can include, as shown in FIG. 20, showing an exemplary design information for a solar module array. The design information can be based on the surface analysis (e.g., terrain analysis; an example is shown in FIG. 17A) and other environment parameters analysis (e.g., wind, precipitation). The design information can be further based on the required energy outputs. The design information can comprise the locations to install the posts, the driving depth of the posts, the height of the posts, the distances between the posts, the number of the posts, the number of the modules, the orientation of the modules, the angles of the modules, and/or the spacing between the modules. The design information can be exported, loaded, and/or stored in the installation machinery to guide the installation of posts and/or modules. The surface analysis can be used to evaluate precise locations of array components, e.g., the post, the solar module, and/or the racking/assembly components. FIG. 17B shows a digital representation of the predicted and/or design array components at the terrain.

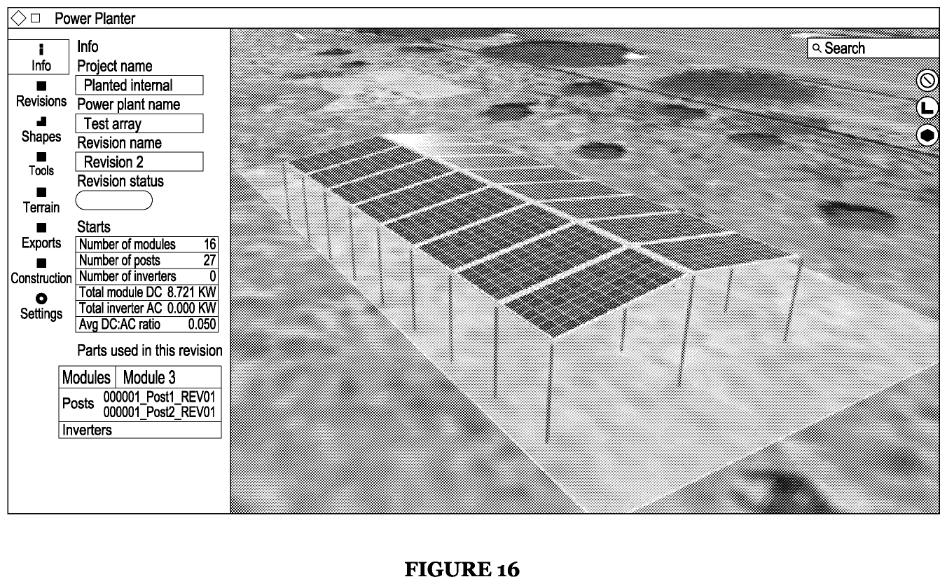

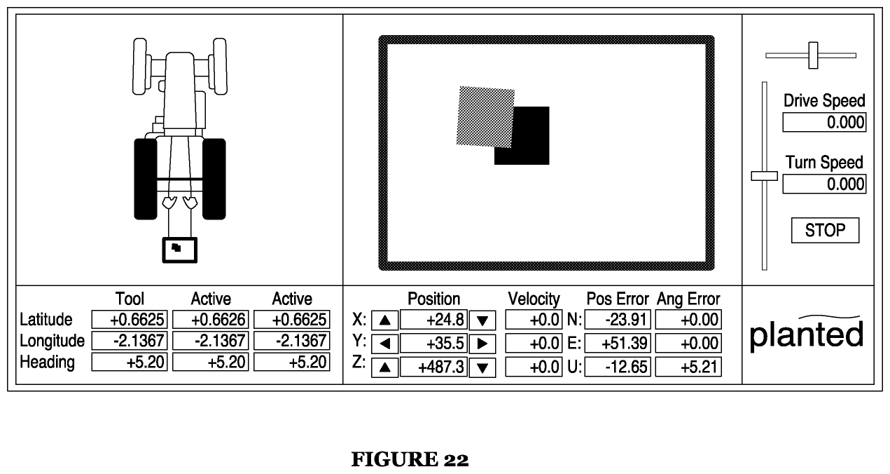

Receiving an array design can include generating a digital representation of the design of the array. Receiving an array design can include providing a graphic user interface (GUI) to display an a digital representation (e.g., an example of a digital representation of a post and module assembly is shown in FIG. 16). The digital representation can be used for design, evaluation, construction, operations, and maintenance of the post and solar module system. The digital presentation can include a GUI interface for the display parameters, for example, number of modules, number of posts, number of inverters, total module DC, total inverter AC, Average DC: AC ratio, and/or any additional parameters. The GUI interface can also comprise input information, for example, the project name, the power plant name, revision name, and revision status. FIG. 22 shows an example of a GUI for determining a landscape topography for positioning and assembling solar modules.

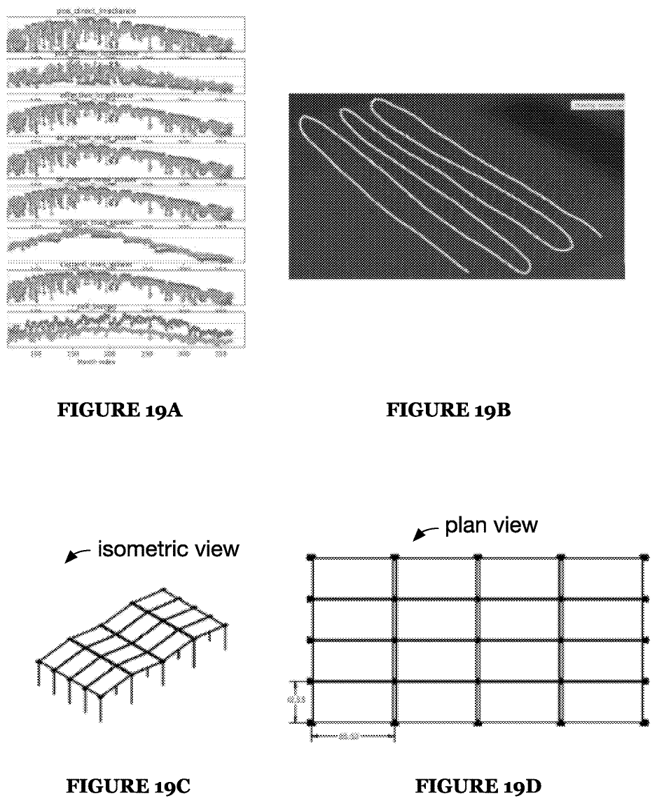

In a first specific example, the digital representation can be used to predict the electric (or electrical) power produced by the array. FIG. 19A shows example data of the calculation for electric power produced by the array. In some embodiments, the digital representation of the design array can be used to predict the cost of the array. In some embodiments, the digital representation can be used to predict the cost of the energy produced by the array.

In second specific example, the digital representation can be used to calculate the number of the required components of the array. In some embodiments, the digital representation of the design array is used to create construction plan drawings. In some embodiments, 2D drawings can be exported from the digital representation to guide or direct the construction. FIG. 19B shows an exemplary isometric view of a design array exported from the digital representation. FIG. 19D shows an exemplary plan view of a design array exported from the digital representation. The spacing or distance of the posts, the height of the post above the ground, and/or the angle of the post-module interface can be displayed on the 2D drawings.

In a third specific example, the digital representation can be used to generate a plan and/or analysis for construction operations of the array. FIG. 19C shows an exemplary instruction path plan for an installation/construction. The lines in FIG. 19C indicates the optimized construction path plan.

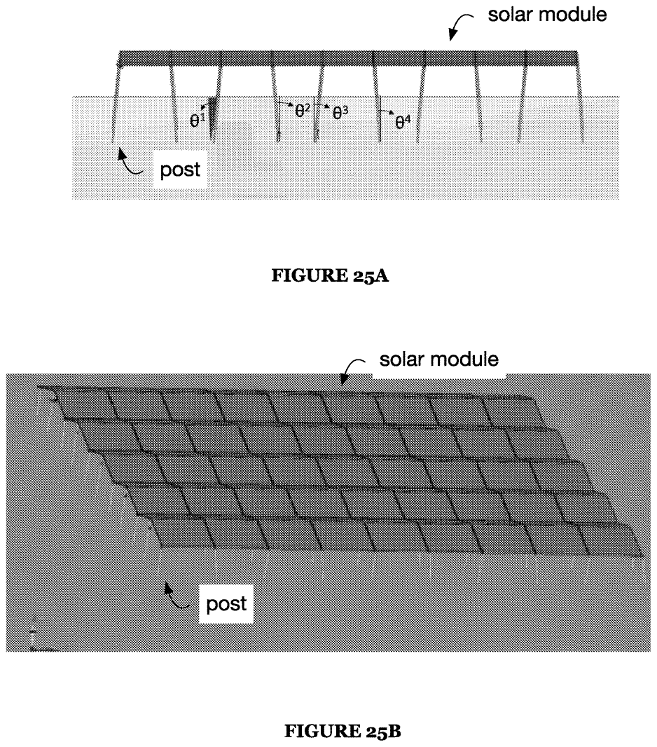

Deploying a solar array S600 can include installing posts (e.g., using variations of the mobile platform described in Section 3 above), which functions to drive posts for supporting the array of solar panels into the measured/characterized terrain (e.g., for ground-mount solar systems), but can alternatively not include installing posts. Installing posts can include installing a plurality of posts. The plurality of posts can include a row of posts in which two adjacent posts in the row of posts are each tilted toward one another, in which a third post adjacent to the two adjacent posts is tilted away. In some embodiments, the posts can be installed at alternating angles. In some embodiments, the non-parallel configuration of the posts (e.g., installation at alternating angles) creates an interlocking structure of the posts with regards to forces on the posts. In an arrangement of a row of posts, the angles of the posts (e.g., θ) can be different (e.g., as shown in FIG. 25A). Alternatively, the angles of the posts can be substantially same (e.g., as shown in FIG. 26A) or include a combination of substantially identical and different angles (e.g., as shown in FIG. 26B). The interlocking structure can engage better with the soil. In some embodiments, the interlocking structure can resist much higher forces. In some embodiments, at least a row of posts can be installed at alternating angles. In some embodiments, at least a portion of a row of posts can be installed at alternating angles (e.g., as shown in FIG. 25A-B). In some embodiments, the installation of posts at alternative angles can be determined by the location of installation, the environment of the location, the quality of the soil (e.g., soft or hard/dense soil layer), and the terrain surface (e.g., flat or non-flat).

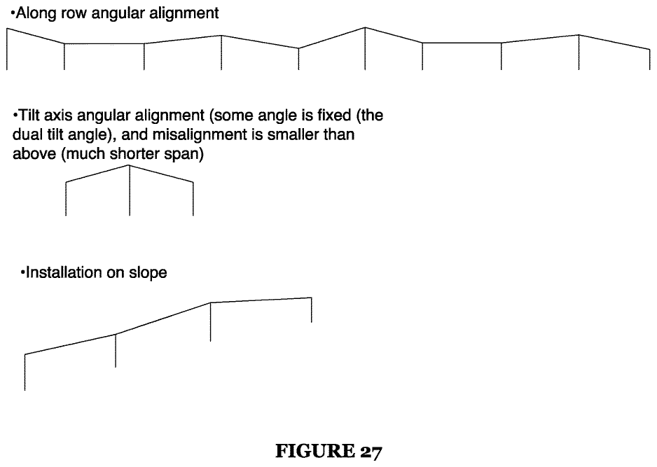

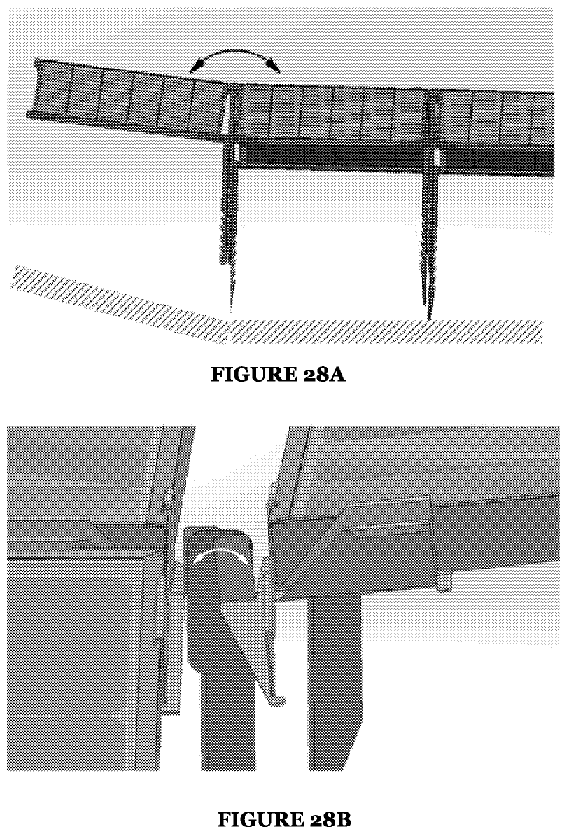

FIG. 27 shows main tolerances of concern for a solar array installation, in accordance with some embodiments. In some cases, spacing between posts and/or angles of solar modules may be adjusted along a row, such that the solar array can be positioned or aligned in a desired orientation. FIG. 27 shows a tilt axis angular alignment, in accordance with some embodiments. In some cases, the angular orientation of the solar modules may be fixed or movable. In some cases, the solar modules may have a dual tilt angle. In some embodiments, the solar module array comprises a dual tilt array (e.g., as shown in FIG. 36A). FIG. 27 shows ground mount installation on a slope, in accordance with some embodiments. In some cases, a tracker may adjust an angle of a solar module from at least about 1° to about 10° or more in addition to the angle of the slope. FIG. 28A shows a side perspective view indicating the impact of uneven terrain upon installation, in accordance with some embodiments. FIG. 28B is an enlarged view showing the ability of the components of some embodiments disclosed herein, which may rotate relative to each other in order to accommodate tolerances.

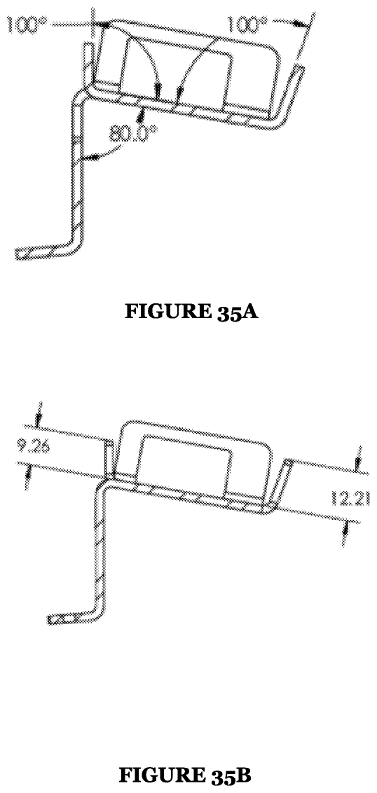

Deploying a solar array S600 can include installer a post-module interface. In some embodiments, the ground may have a movement in a vertical or lateral direction. In some embodiments, the ground may heave and cause a change in the surface (e.g., topography). In some embodiments, the post-module interface can include flexibility to enable contouring the solar module to the terrain after installation, during the lifetime of the solar module, and/or in a situation the terrain has a change or movement. FIGS. 35A and 35B are examples of post-module interfaces with a flexible surface. In some embodiments, the flexible surface can be non-flat. In some embodiments, the flexible surface can flex for 1° to 30°.

Deploying a solar array S600 is preferably performed using the post installer on the mobile platform, but can alternatively be performed with an operator and/or any other machinery. In a variant, deploying a solar array S600 can include inserting a post into the ground.

Deploying a solar array S600 can include installing solar modules, which functions to install solar modules onto one or more posts provided as described above, but can alternatively not include installing solar modules.

Deploying a solar array S600 is preferably performed using the solar module installer on the mobile platform, but can alternatively be performed with an operator and/or any other machinery.

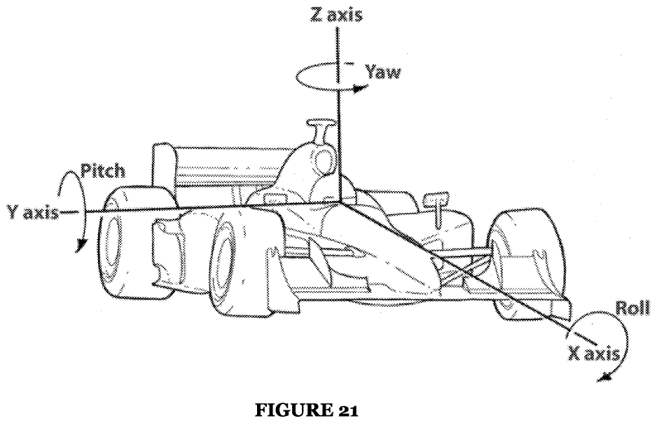

In an illustrative example, deploying a solar array S600 can include a GPS guided machine (e.g., the mobile platform) steering to the correct post location. The GPS guided machine can be equipped with a hopper (e.g., a post feeder) which stores bulk posts. In some cases, the machine can singulate one post from the bulk posts using a post singulator. In some variants, a post installer of the machine can automatically feed the post to a hammer and the hammer can drive the post into the ground. In an example, the post installer of the machine can include a roller to retain the post while it is driven into the ground. In an example, the machine can install posts positioned with control over X, Y, Z, Tip and Tilt to follow the terrain as instructed by the software (e.g., the array design). FIG. 21 shows a coordinate system for describing a moving vehicle.

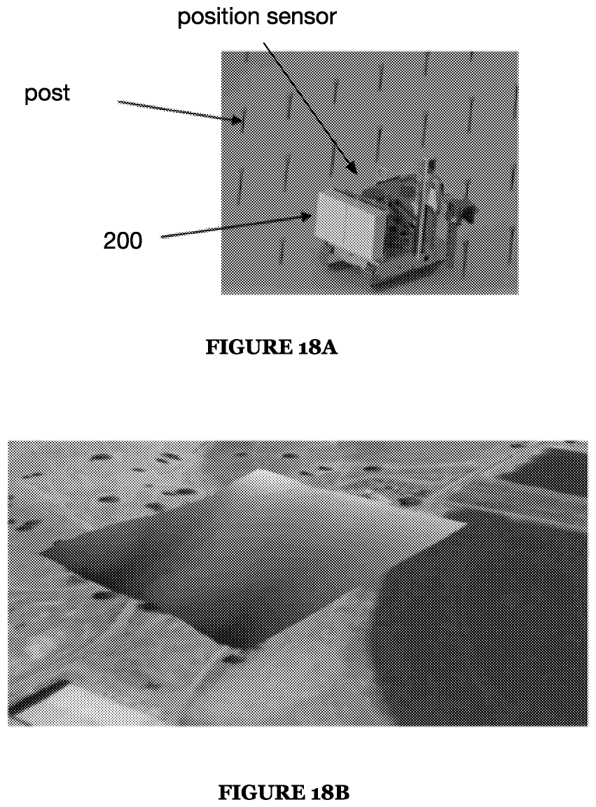

In a specific example, during the installation of the post and/or solar module, a sensor (e.g., a geolocation sensor) can be used to record data (e.g., the location of the ground, the location of the posts, the number of posts installed, the height of the post above the ground, the angles of the posts, the distance between the posts, etc.). In some examples, the recorded data can be fed into the computer program product to update or modify the digital model, which can be further used for analysis, design, and construction of the posts and solar modules. FIG. 18A shows a sensor to record array and terrain data during the installation. A mobile platform is moving over a terrain to install a plurality of posts. The mobile platform can include a sensor to obtain data of the terrain and/or the installed posts. FIG. 18B shows an example of an updated digital model with data from the sensor.

However, the deploying a solar array S600 may be otherwise configured.

### 5. Conclusions

While various embodiments of the disclosure have been shown and described herein, it will be obvious to those skilled in the art that such embodiments are provided by way of example only. Numerous variations, changes, and substitutions may occur to those skilled in the art without departing from the disclosure. It should be understood that various alternatives to the embodiments of the disclosure described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “real time” or “real-time,” as used interchangeably herein, generally refers to an event (e.g., an operation, a process, a method, a technique, a computation, a calculation, an analysis, a visualization, an optimization, etc.) that is performed using recently obtained (e.g., collected or received) data. In some cases, a real time event may be performed almost immediately or within a short enough time span, such as within at least 0.0001 millisecond (ms), 0.0005 ms, 0.001 ms, 0.005 ms, 0.01 ms, 0.05 ms, 0.1 ms, 0.5 ms, 1 ms, 5 ms, 0.01 seconds, 0.05 seconds, 0.1 seconds, 0.5 seconds, 1 second, or more. In some cases, a real time event may be performed almost immediately or within a short enough time span, such as within at most 1 second, 0.5 seconds, 0.1 seconds, 0.05 seconds, 0.01 seconds, 5 ms, 1 ms, 0.5 ms, 0.1 ms, 0.05 ms, 0.01 ms, 0.005 ms, 0.001 ms, 0.0005 ms, 0.0001 ms, or less.

In some embodiments, the systems and methods described can include or implement architecture comprising a machine learning (ML) algorithm. In some cases, the machine learning algorithm may comprise a neural network. Examples of neural networks can include, for instance, a deep neural network (DNN), a convolutional neural network (CNN), a recurrent neural network (RNN), and/or a generative adversarial network (GAN).

In some embodiments, the machine learning algorithm may comprise a deep neural network (DNN). In other embodiments, the deep neural network may comprise a convolutional neural network (CNN). The CNN may be, for example, U-Net, ImageNet, LeNet-5, AlexNet, ZFNet, GoogleNet, VGGNet, ResNet18, or ResNet, etc. In some cases, the neural network may comprise or utilize, for example, a deep feed forward neural network, a recurrent neural network (RNN), LSTM (Long Short Term Memory), GRUs (Gated Recurrent Units), autoencoders (e.g., variational autoencoders, adversarial autoencoders, denoising autoencoders, or sparse autoencoders), a Boltzmann machine (BM), a RBM (Restricted BM), a deep belief network, a generative adversarial network (GAN), a deep residual network, a capsule network, or one or more attention/transformer networks. In some embodiments, the neural network may comprise a plurality of neural network layers. In some cases, the neural network may have at least about 2 to 1000 or more neural network layers.

In some cases, the machine learning algorithm may comprise a support vector machine (SVM), a classification algorithm, a regression analysis algorithm, or any other type of supervised, semi-supervised, or unsupervised machine learning algorithm. In some embodiments, the supervised learning algorithm may comprise or utilize, for example, support vector machine algorithms, linear regression algorithms, logistic regression algorithms, linear discriminant analysis algorithms, k-nearest neighbor algorithms, similarity learning, or any combination thereof. In some embodiments, the unsupervised learning algorithm may comprise, for example, clustering algorithms, hierarchical clustering algorithms, k-means clustering algorithms, mixture models, anomaly detection, local outlier factor algorithms, autoencoders, deep belief networks, Hebbian learning, self-organizing maps, expectation-maximization algorithms (EM), principal component analysis algorithms, independent component analysis algorithms, non-negative matrix factorization, singular value decomposition, or any combination thereof. In some cases, the machine learning algorithm may comprise or utilize a random forest, a decision tree (e.g., a boosted decision tree), a classification tree, a regression tree, a bagging tree, or a rotation forest.

In some embodiments, the algorithm may be configured to identify the location for surveying terrain and/or deploying one or more solar modules and/or posts based at least on an analysis of terrain data. In some embodiments, the terrain data is obtained using at least one of aerial imaging or Global Navigation Satellite Systems (GNSS).

In some embodiments, the method may further comprise creating a set of executable instructions in a digital medium for an autonomous system to autonomously position, deploy, install, and/or assemble the at least one solar module to construct a solar module array. In some embodiments, the autonomous system comprises a plurality of field machines that are in operative communication via a network. In some embodiments, the plurality of field machines comprises one or more robots. In some embodiments, the method may further comprise creating a set of executable instructions in a digital medium for an autonomous system to autonomously position, deploy, install, and/or assemble one or more posts or other supporting structures for one or more modules of a solar module array.

In some embodiments, the present disclosure provides a method for determining a location suitable for using an algorithm to identify the location suitable for autonomous positioning and assembly a post and a solar module. In some embodiments, the method further comprises creating a set of executable software instructions for controlling one or more mobile platforms to autonomously position and assemble a plurality of posts and a plurality of solar modules over a terrain to construct an array of solar modules without requiring aid or involvement from a user.

Although omitted for conciseness, the preferred embodiments include every combination and permutation of the various system components and the various method processes, wherein the method processes can be performed in any suitable order, sequentially or concurrently.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

Additional or alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method comprising:
acquiring a first set of three-dimensional (3D) data points of a measurement object using a 3D survey apparatus, wherein the measurement object is disposed on a mobile platform;
concurrently with acquiring the first set of 3D data points, acquiring a second set of 3D data points using a position sensor disposed on the mobile platform, wherein the first set of 3D data points and the second set of 3D data points are acquired in different coordinate frames; and
estimating a pose of the 3D survey apparatus in a coordinate frame of the position sensor based on a difference between the first set of 3D points and the second set of 3D points.

2. The method of claim 1, wherein the first position and the second position are not aligned with geodetic control positions.

3. The method of claim 1, wherein the 3D survey apparatus is coupled to a mobile platform.

4. The method of claim 1, wherein the measurement object and the position sensor have a fixed and known spatial relationship on the mobile platform.

5. The method of claim 3, wherein the measurement object is disposed on an end effector of the mobile platform.

6. The method of claim 4, wherein the position sensor is disposed on an end effector of the mobile platform.

7. The method of claim 1, wherein the method excludes levelling the 3D survey apparatus and the measurement object.

8. The method of claim 1, further comprising:
generating a predicted position of the measurement object in the coordinate frame of the 3D survey apparatus based on the pose of the 3D survey apparatus and the second set of 3D data points,
determining a residual between the predicted position and a measured position of the measurement object in the coordinate frame of the 3D survey apparatus;
detecting a disturbance of the 3D survey apparatus based on the residual exceeding a threshold.

9. The method of claim 8, wherein detecting a disturbance triggers a re-estimation of the pose of the 3D survey apparatus.

10. The method of claim 1, wherein the measurement object is moved to different positions between acquisition of the first set of 3D data points.

11. A system comprising:
a mobile platform comprising a measurement object and a position sensor, wherein the spatial relationship between the measurement object and the position sensor is known;
a 3D survey apparatus with a line of sight to the measurement object, wherein:
the 3D survey apparatus is configured to acquire a first set of 3D data points of the measurement object, and
the position sensor is configured to acquire a second set of 3D data points at a different location relative to the 3D survey apparatus; and
a processor in communication with the 3D survey apparatus and the position sensor configured to estimate an estimated pose of the 3D survey apparatus in a coordinate frame of the position sensor based on a difference between the first set of 3D points and the second set of 3D points.

12. The system of claim 11, wherein an error in the estimated pose manifests as a constant offset applied uniformly to measurements made using the estimated pose, without introducing relative error between individual measurements.

13. The system of claim 11, wherein the processor is further configured to initialize the pose estimate using a first data point in the second set of 3D data points and optimize the difference using first set of 3D data points.

14. The system of claim 11, wherein:
the first set of 3D data points is associated with the mobile platform comprising a first trajectory and a first set of timestamps generated using a first clock, and
the second set of 3D data points is associated with a second trajectory and associated with a second set of timestamps generated using a second clock that is not synchronized with the first clock.

15. The system of claim 14, wherein the 3D survey apparatus is disposed on a second mobile platform associated with the second trajectory.

16. The system of claim 11, wherein the first set of 3D data points and the second set of 3D data points are acquired at different frequencies.

17. The system of claim 16, further comprising synchronizing the first set of 3D data points and the second set of 3D data points based on a relationship between clock parameters of the first clock and the second clock.

18. The system of claim 17, wherein the relationship is determined by interpolating a timestamp between two timestamps from the second set of timestamps based on the difference between one point in the first trajectory and two points in the second trajectory.

19. The system of claim 11, wherein the processor is further configured to periodically estimate an updated pose based on a set of most recent 3D data points from the first set of 3D data points and the second set of 3D data points.

20. The system of claim 19, wherein the process is further configured to detect a disturbance in response to a difference between the updated pose and the estimated pose exceeding a threshold.
